(19) United States
(12) Patent Application Publication
(10) Pub. No.: US 2026/0238863 A1
(43) Pub. Date: Aug. 13, 2026

(54) LASER SPOT CANCELLATION

(71) Applicant: Motional AD LLC, Boston, MA (US)

(72) Inventor: Yew Kwang Low, Singapore (SG)

(21) Appl. No.: 19/640,812

(22) Filed: Apr. 7, 2026

Related U.S. Application Data
(63) Continuation of application No. PCT/US2024/050563, filed on Oct. 9, 2024.
(60) Provisional application No. 63/589,562, filed on Oct. 11, 2023.

(51) Int. Cl. H04N 23/11; G01S 17/86; G01S 17/931; G06T 7/70; H04N 23/16; H04N 23/71; H04N 23/80

(52) U.S. Cl. CPC H04N 23/11; G01S 17/86; G01S 17/931; G06T 7/70; H04N 23/16; H04N 23/71; H04N 23/80; G06T 2207/10048; G06T 2207/30252

(57) ABSTRACT

Various imaging systems and methods are disclosed for identifying and eliminating spots associated with infrared light beams emitted by range finding and detection systems, on a digital image of a scene. An imaging system generates images of a single scene on image sensors having different spectral responses and uses the resulting image signals to reduce or eliminate spots on a modified digital image. Additionally, the imaging system uses the image signals to monitor the performance the image sensors and generate alert signals an indication of an image sensor malfunction is detected.

### INCORPORATION BY REFERENCE TO ANY PRIORITY APPLICATIONS

This application is a continuation of PCT Patent Application No. PCT/US2024/050563, filed on Oct. 9, 2024, entitled “LASER SPOT CANCELLATION,” which claims the priority benefit of U.S. Provisional Patent Application 63/589,562, entitled LASER SPOT CANCELLATION, filed Oct. 11, 2023, each of which is incorporated herein by reference in its entirety.

### BRIEF DESCRIPTION OF THE DRAWINGS

FIG. 1 schematically illustrates a vehicle equipped with a Light Detection and Ranging (lidar) system and an imaging system for range finding, detection, and imaging objects, and other vehicles in an environment. The inset shows an image captured by the imaging system.

FIG. 2A is a block diagram illustrating an example imaging system having two image sensors that capture visible (VIS) and near infrared (NIR) perspective of a scene for identifying and eliminating laser spots in digital images generated based on the VIS perspective.

FIG. 2B is a block diagram illustrating an example arrangement of optical components that can be used by the imaging system shown in FIG. 2A.

FIG. 2C is a block diagram illustrating another example arrangement of optical components that can be used by the imaging system shown in FIG. 2A.

FIG. 3 is a diagram illustrating temporal alignment between the optical probe signals emitted by a lidar system and an imaging control signal generated by the control and processing system when the lidar system is synchronized with the imaging system.

FIG. 4 is a diagram illustrating images generated using the visible and near infrared image sensors of the imaging system shown in FIG. 2A in the presence and absence of the lidar probe signals emitted by a by a lidar system of the vehicle that carries the imaging system.

FIG. 5 is a simplified flow diagram illustrating an example process for reducing or potentially eliminating NIR spots from digital images generated by an imaging system, generating alerts indicating failure of an image sensor of the imaging system, generating warnings indicating the potential presence of an object in the scene, or determining a profile of a vehicle.

FIG. 6A is a flow diagram illustrating steps for excluding NIR spots illuminated on the image sensors from an image generated by the imaging system, or generating alerts when the signature of a NIR spot or an image portion identified in an image associated with one of the image sensors is missing from the other image sensor.

FIG. 6B is a flow diagram illustrating steps for distinguishing the NIR spots generated by a lidar system synchronized with the imaging system shown in FIG. 2A and those generated by another lidar system and determining a make, or type of the other lidar system.

FIG. 7 is an example environment in which a vehicle including one or more components of an autonomous system can be implemented.

FIG. 8 is a diagram of one or more systems of a vehicle including an autonomous system.

FIG. 9 is a diagram of components of one or more devices and/or one or more systems of FIGS. 7 and 8.

FIG. 10 is a diagram of certain components of an autonomous vehicle compute system.

### DETAILED DESCRIPTION

### Camera and Lidar System Overview

Vehicles (e.g., autonomous self-driving vehicles), can use a combination of sensors and imaging systems for detecting and identifying objects in a surrounding environment, and determining distances and velocities of the detected objects with respect to the vehicle. Additionally, a vehicle can use an imaging system to provide an image of a scene or a surrounding environment to a user (e.g., a user inside the vehicle or a user in wireless communication with the imaging system). In various implementations, the imaging and sensing system of a vehicle can include a light source, a camera (e.g., a digital camera), and/or a Light Detection and Ranging (lidar) system.

A lidar system, also referred to as laser-based range finder, a laser range finder, or Laser Detection and Ranging or ladar system, can use light beams (e.g., laser beams) to detect objects in an environment surrounding the lidar system and determine their distances from the lidar system. A lidar system can include a lidar emission subsystem that emits optical probe beams, and a lidar detection subsystem that receives the reflected optical probe beams and generates return signals. The lidar detects objects by sending optical probe beams to the environment and detecting the respective optical reflections off of the objects in the environment. The detection subsystem generates a return signal indicative of detection of a portion of an optical probe beam reflected by an object in the environment. In some applications (e.g., to control and guide an autonomous vehicle in a complex driving environment), the lidar continuously scans an environment (e.g., environment surrounding the vehicle) using optical probe beams emitted to the environment along different directions.

In some implementations, optical probe beams can have wavelengths within an operating wavelength range of a lidar system. In some cases, the operating wavelength range of the lidar is in the infrared (IR) wavelength range. For example, the operating wavelength range of the lidar can be within near-IR (NIR) wavelength range. The NIR wavelength range can include wavelengths from 700 nm to 1100 nm, or from 700 nm to 1800 nm. In some examples, the imaging system of a vehicle can have a spectral sensitivity that at least partially overlaps with the operating wavelength range of a lidar system that emits optical probe in the environment scanned by the lidar system. For example, an image sensor of the imaging system can be sensitive to light having wavelength within the IR wavelength range, or more specifically within the NIR wavelength range. As a result, the optical probe beams emitted by a lidar can generate bright spots (e.g., associated with NIR illumination) in an image (e.g., a digital image) of a scene captured by the imaging system. Bright spots generated by NIR light are referred to as NIR spots.

In some cases, a bright spot (e.g., a NIR spot) can be a generated by a light beam (e.g., a NIR light beam). In some cases, the light beam can be a laser beam. In such cases, the bright spot is referred to as laser spot.

In some examples, a NIR spot can be a distinct region on a digital image generated using an image signal received from an image sensor having a spectral sensitivity that at least partially overlaps with the NIR wavelength range. In some examples, the distinct region of the image can have a greater brightness than a surrounding region of the image. In some examples, the distinct region includes a region within which an image of a portion of scene in the vicinity of an aperture from which a NIR light beam is emitted, can be formed in the absence of the NIR light beam.

In various implementations, a bright spot (e.g., a NIR spot, a ghost artifact) on a digital image can be a region of the digital image (a subset or group of pixels) have a brightness level larger than a threshold brightness level. In some examples, the threshold brightness level brightness level can constitute a false positive object detection over the digital image. I some examples, the threshold brightness can be larger than a mean value of the brightness level over the digital image by 2 times, 4 times, 6 time, 10 times a standard deviation of brightness level of the digital image, or larger values.

In some cases, a vehicle (e.g., an autonomous vehicle or AV) moves in an environment where other vehicles (e.g., other AVs) equipped with light sources and lidar systems that emit IR or NIR light are also moving. In some such cases, the optical probe beams emitted by the lidar systems of other vehicles can generate NIR spots in an image captured by an imaging system of the vehicle. A NIR spot can obstruct or distort formation of an image of a portion of a scene by the imaging system, which could have been imaged in the absence of the NIR spot. In some cases, these NIR spots can interfere with the operation of the imaging system and affect the performance of a navigation system of the vehicle. In some cases, a NIR spot generated by a laser beam emitted by a laser source in the environment is be referred to as a “laser spot”. In some examples, a NIR spot in an image can be generated by non-laser light emitted by a light source in an environment surrounding the imaging system. A light source can be a moving light source (e.g., a lidar system mounted on a vehicle), or a fixed light source. A light beam emitted by a light source can include wavelengths in the visible (VIS) wavelength range (e.g., from 400 nm to 700 nm), infrared (IR) wavelength range (e.g., from 800 nm to 5000 nm), or both. In some cases, light beams emitted by the light sources used for detection, sensing, range finding, or night vision, can have a high intensity and can be highly directional. For example, a laser beam emitted by a lidar can be a collimated beam having a small cross-section and a high intensity. Examples, of light sources that can generate high intensity IR light beams can include, but are not being limited to, emission subsystems of lidar systems (e.g., NIR lidar systems), light sources (e.g., NIR light sources) of speed sensors, light sources of a night vision systems (e.g., NIR illuminated night vision systems), and the like.

To reduce or eliminate NIR spots associated with NIR light beams, some conventional imaging systems can use optical filters (e.g., within an optical train) to attenuate the IR light received by an image sensor. Given the sensitivity of the most image sensors and the high intensity of the IR light beams that can enter the aperture of the imaging system, the attenuation provided by such optical filters can not completely eliminate or sufficiently reduce these NIR spots. Also, image sensors that have broad band sensitivity in visible and NIR range (e.g., InGaAs based image sensors), are not technologically mature and ready to be used for eliminating NIR spots.

The disclosed methods and systems can significantly reduce and potentially eliminate NIR spots in a digital image of a scene generated by an imaging system in the presence of IR light sources (e.g., NIR light sources) in the scene. In some examples, the imaging system can form a first and a second images of a scene on a first and a second sensors respectively. The first and the second images can be formed via a first optical path and a second optical path, different from the first optical path, respectively. In some cases, the first optical path can be configured to selectively transmit light having wavelengths within a first wavelength range (e.g., VIS wavelength range) and the second optical path can be configured to selectively transmit light having a wavelength within a second wavelength range (e.g., NIR wavelength range). In some cases, the first optical path can be configured to provide greater optical transmission for light having wavelengths within the first wavelength range compared to light having wavelengths within the second wavelength range. In some such cases, the second optical path can be configured to provide greater optical transmission for light having wavelengths within the second wavelength range compared to light having wavelengths within the first wavelength range.

In some examples, the two different optical paths can be generated by a dichroic beam splitter that transmits light having wavelength within a first wavelength range (e.g., visible wavelength range) and redirects light having a wavelength within a second wavelength range (e.g., NIR wavelength range). Additionally, or alternatively, one or more optical components in the first optical path can be configured to reject light having wavelengths within having a wavelength within the second wavelength range (e.g., NIR wavelength range) and one or more optical components in the second optical path can be configured to reject light having wavelengths within the first wavelength range.

In some cases, the first and second images can be substantially identical images of the same scene having the same magnification but with different spectral distributions. For example, the first image can have a spectral distribution with a peak wavelength in visible wavelength range and the second image can have a spectral distribution with a peak in the near infrared wavelength range.

In some embodiments, the first and the second image sensors can be substantially identical images sensors, have similar or substantially identical spectral responses, and/or comprise the same light sensitive material. For example, both image sensors can be vision or VIS sensors having sensitivity from 400 nm to 1100 nm with a peak spectral response within VIS wavelength range (e.g., from 400 nm to 700 nm). In some examples, both image sensors can be silicon-based sensors.

In some implementations, the first image sensor has high sensitivity (or a peak sensitivity) in the visible (VIS) wavelength range and the second image sensor has high sensitivity (or a peak sensitivity) in the in NIR wavelength range. An image sensor having high sensitivity (or a peak sensitivity) in the visible (VIS) wavelength range can be referred to as VIS image sensor and an image sensor having high sensitivity (or a peak sensitivity) in the in NIR wavelength range can be referred to as NIR image sensor. In some cases, the first and the second wavelength ranges can be non-overlapping (i.e., mutually exclusive) or partially overlapping. In some examples, the first image sensor can be sensitive to light between 0.4 to 0.7 micrometers and the second image sensor can be sensitive to light between 0.7 to 1.8 micrometers. In some other examples, the first image sensor can be sensitive to light between 0.5 to 1.3 micrometers and the second image sensor can be sensitive to light between 0.7 to 2.2 micrometers. In some examples, a difference between a peak response wavelength of the first image sensor and the second image sensor can be form 10 nm to 50 nm, form 50 nm to 100 nm, from 100 nm to 300 nm, from 300 nm to 500 nm or any ranges formed by these values or larger or smaller values. In some cases, where the two image sensors have different spectral sensitivities, the first and the second images can be substantially identical images of the same scene having the same magnification and spectral distribution. In some such cases, the first and the second optical paths through which the first and the second images are formed, can provide similar or substantially identical spectral transmissions. For example, both paths can provide the same amount of optical transmission for light having wavelengths in the NIR wavelength range and light having wavelength within the VIS wavelength range. In some cases, e.g., when the two image sensors have different spectral sensitivities, the two different optical paths can be generated by a beam splitter that does not discriminate between NIR and VIS wavelengths (e.g., a beam splitter having the same splitting ratio for light having wavelengths within NIR wavelength range and light having wavelengths within VIS wavelength range).

The imaging system can process and modify a first digital image of the scene, generated using the first image sensor, based at least in part on a second digital image of the same scene, generated using the second image sensor, to generate a modified digital image. In some cases, the brightness of NIR spots in the modified digital image can be significantly lower than NIR spots in the first digital image. In some cases, a number of NIR spots in the modified digital image can be significantly smaller than a number of NIR spots in the first digital image.

In some cases, the imaging system compares the first and the second digital images of the same scene to identify the NIR spots generated by NIR light beams and generates the modified digital image by excluding, attenuating, reducing, or otherwise modifying the identified NIR spots. For example, the imaging system can identify a distinct spot (e.g., a bright spot) in the first image and upon finding a respective spot on the second digital image having a high brightness level than the distinct spot on the first digital image, identify the distinct spot as a NIR post and remove it from the first digital image. In some cases, the respective spot on the second digital image can be a spot having substantially similar size, shape, and/or coordinate (e.g., with respect to a common image coordinate) as the distinct spot on the first digital image. In various examples, the modified digital image can be free of NIR spots, having smaller number of NIR spots, having smaller NIR spots, or less distinct NIR spots. In some examples, the first and the second image sensors are synchronized to output image signals associated with the same scene and at the same time. In some cases, the images formed on the first and the second images sensors can be images of the same portion of the scene with different spectral properties but otherwise identical (e.g., having the same magnification).

In some embodiments, the imaging system can be synchronized with a lidar system to distinguish the NIR spots associated with reflections of the NIR light beams emitted by the lidar system and those associated with NIR light beams emitted by other light sources in the surrounding environment (e.g., lidar systems of other vehicles). In some cases, the imaging system and the lidar system are mounted on the same vehicle (e.g., an AV). Advantageously, by distinguishing one or more NIR spots generated by light beams emitted by the lidar system of the vehicle that carries the imaging system from those generated by a lidar system of another vehicle, the imaging system can identify the lidar system (e.g., a type or make of the lidar system) of the other vehicle based on a characteristic of the corresponding of NIR spots. Subsequently, the imaging system can identify a profile and/or a make of the other vehicle based on the identified lidar system. In some cases, the imaging system can identify a location of the lidar system with respect to the other vehicle (e.g., based on the corresponding NIR spots) and identify a profile and/or a make of the other vehicle based on the identified location of the lidar system. In some examples, characteristics of one or more NIR spots identified in an image (e.g., digital image), can include one or both of a temporal pattern or a spatial pattern. Different lidars can have different pulse signatures (e.g., a packet of lidar pulse can include different sequencing of sub pulses in terms of varying sub pulse widths and pause duration) and these pulse signatures are captured by the NIR spots; as such temporal pattern or a spatial pattern of NIR spots can be used to identify a lidar system.

The imaging systems, and methods described below could be incorporated into such various type of autonomous vehicles and self-driving cars for examples those disclosed in U.S. patent application Ser. No. 17/444,966, entitled “END-TO-END SYSTEM TRAINING USING FUSED IMAGES” and filed Aug. 12, 2021, and Ser. No. 17/443,433, entitled “VEHICLE LOCATION USING COMBINED INPUTS OF REDUNDANT LOCALIZATION PIPELINES” and filed Jul. 26, 2021, the entire contents of which are incorporated by reference herein and made a part of this specification.

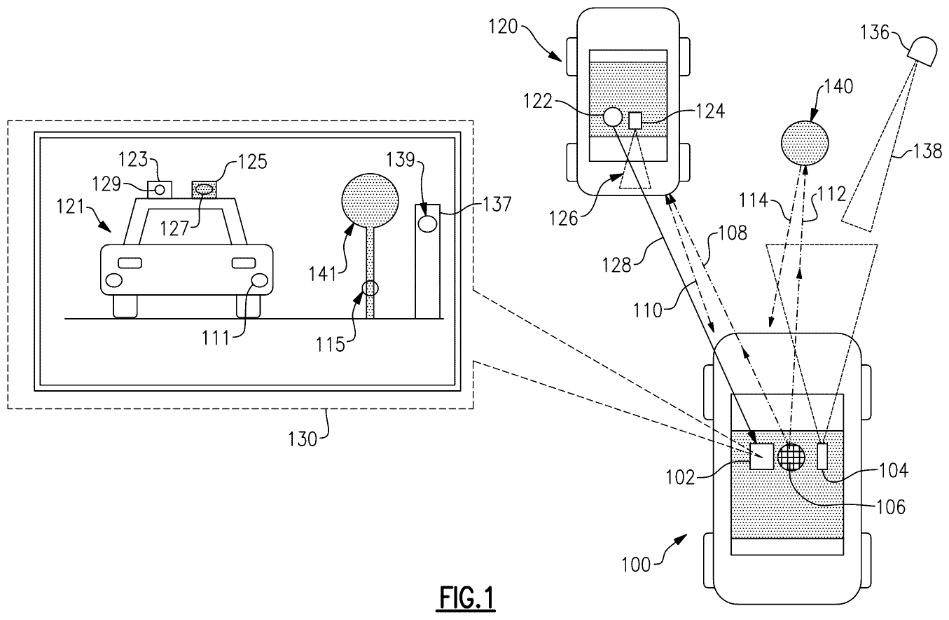

FIG. 1 schematically illustrates a vehicle 100 equipped with a Light Detection and Ranging (lidar) system 106 and an imaging system 102 for range finding, detection, and imaging objects (both luminous and non-luminous objects), and other vehicles in an environment surrounding the vehicle 100. In some cases, the vehicle 100, can be an autonomous or semi-autonomous vehicle (e.g., a vehicle having a driving automation level from 1-6 as defined by The Society of Automotive Engineers or SAE). The imaging system 102 includes at least one digital camera configured to generate images of a portion of the environment. In some cases, the images generated by the imaging system 102 of the vehicle 100 can include modified digital images generated by processing two or more digital images or digital image signals received from two or more image sensors (e.g., sensors having different spectral responses). Additionally, vehicle 100 can include a light source 104 that illuminates a scene to enhance the images of the scene generated by the imaging system 102.

The lidar system 106, generates and steers optical probe beams and receives reflections of the optical beams to detect objects in the environment. In various implementations, the lidar system 106 can be a scanning lidar system, or a mechanical lidar system. A scanning lidar system scans one or more optical probe beams over a wide field of view of a detector while the mechanical lidar system emits a single optical probe beam (e.g., a low divergence optical beam) to illuminate a narrow field of view of a detector and scans (e.g., rotates) the detector and the optical probe beam.

In some cases, the imaging system 102 (e.g., a digital camera) generates images (e.g., digital images) using the image signals (digital image signals) received from one or more image sensors. The imaging system 102 can include one or more optical components that receive light from the environment and form images on two or more image sensors. The optical components can form optical trains positioned along optical paths from the environment to the image sensors. In some cases, a first optical train that directs light from the environment to the first image sensor through a first optical path can be substantially identical to a second optical train that directs light from the environment to the second image sensor through a second optical path. In some cases, the first and second optical trains can have different spectral transmissions but be otherwise identical (e.g., have the same image formation properties)

In some cases, both optical paths can receive light from the same scene via a common entrance aperture or optical input port. In some examples, at least a portion of the first optical path can overlap with the second optical path. As a result, a first image projected on the first image sensor by the first optical train can be substantially identical to a second image projected on the second image sensor by the second optical train (e.g., having the same magnification). In some implementations, the first image can have a different spectral profile compared to the second image but otherwise be identical to the second image.

One or more image signals generated by the imaging system 102 can be used by a control and processing system to generate an image (e.g., a digital image) of a portion of a scene or surrounding environment. In some implementations, the control and processing system can generate a digital image (e.g., a modified digital image) using at least a first image signal received from the first image sensor and a second image received from the second image sensor. In some examples, the control and processing system generates a first image using the first image signal, generates a second image using the second image signal, makes a comparison between the first and the second images, and generates a third digital image based on the comparison. In some cases, generating the third image can include modifying the first digital image based on the second digital image (e.g., modifying a portion of the first digital image based on the respective portion of the second digital image). In some cases, the control and processing can synchronize the first and second image sensors and/or process the first and second image signals in a synchronous manner, such that the first and the second digital images correspond to images of the same scene captured at the same time. In some implementations, the control and processing can synchronize the imaging system 102 with the lidar system 106. In some such implementations, the first and/or the second image signals are generated in a time interval during which the lidar system 106 is emitting optical probe beams. In some cases, the first and/or the second image signals, or two subsequent images signals received from the first and the second image sensors, are generated in a time interval during which the lidar system 106 does not emit any optical probe beams.

With continued reference to FIG. 1, the control and processing system of the imaging system 102 can generate an image 130 (a digital image) of a scene in the environment. In some cases, image 130 can be generated using an image signal received from an image sensor of the imaging system 102 (e.g., a VIS image sensor). In the example shown, the scene captured by the imaging system 102 includes an incoming vehicle 120, and the light sources and sensors carried by the vehicle 120, an object 140 (e.g., a non-luminous object), and a light source 136 (or a luminous object). Accordingly, image 130 includes a depiction 121 of the incoming vehicle 120, a depiction 141 of the object 140, and a depiction 137 of the light source 136.

In some examples, the incoming vehicle 120 can include a lidar system 122 and a light source 124 that emit light for imaging and range finding. As such image 130 includes a depiction 123 of the lidar system 122 and depiction 125 of the light source 124. In some cases, one, two, or all of the lidar system 122, light source 124, and the light source 136 can emit light having wavelength within a wavelength range (e.g., NIR wavelength range) that at least partially overlap with a spectral response of the image sensor using which the image 130 is generated. In such cases, the lidar system 122, the light source 124 of the vehicle 120, and/or the light source 136 can generate NIR spots on the image 130. In the example shown, the NIR spot 129, 127, and 139, are generated by the light beams 128, 126, and 138, respectively, which are emitted by the lidar system 122, the light source 124, and the light source 136, respectively.

The depictions 121, 141, and 137 can be formed, at least partially, using light generated by a light source in the environment (e.g., light source 136 or other light sources such as sun), and/or light generated by light source 104 of the vehicle 100, or light source 124 of the vehicle 120.

In some cases, the imaging system 102 can include an image sensor with a sensitivity in the NIR range and the light source 104 can generate NIR light. In some such cases, reflection of a probe beam emitted by the lidar system 106 of the vehicle 100 can be reflected by other vehicles and objects in the environment and generate additional NIR spots associated with light generated by the lidar system 106. For example, reflection of the probe beams 112 and 108 by the object 140 and the vehicle 120, respectively, generate the NIR spots 115 and 111, respectively, on the image 130.

As described above, the NIR spots such as NIR spots 129, 127, 111, 115, and 139 can degrade the quality of the image 130 by blocking one or more regions that could be otherwise present image information associated with a region of the scene in vicinity of the corresponding light sources 124 and 136, a light source if the lidar system 122, a region of the vehicle 120, or the object 140 (e.g., a region that receives the probe beams 112 and 108 and generates reflected light beams 114 and 110).

Advantageously, in certain aspects, an imaging system can use at least two different image sensors having different spectral responses and use image signals received from these image sensors to reduce, or potentially eliminate, NIR spots in a modified digital image generated by the imaging system. Further, such imaging system can use image signals received from these image sensors to generate alerts indicating failure of one of the image sensors, generate warnings indicating the potential presence of an object, not observable in a modified digital image, in the scene, or identify NIR spots emitted by the lidar system 122 to determine a profile of a vehicle.

### Imaging System

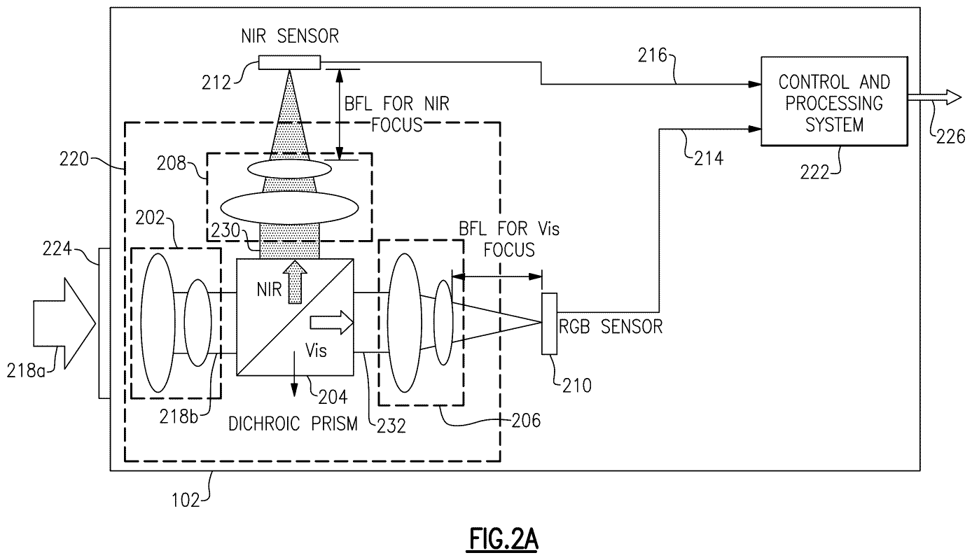

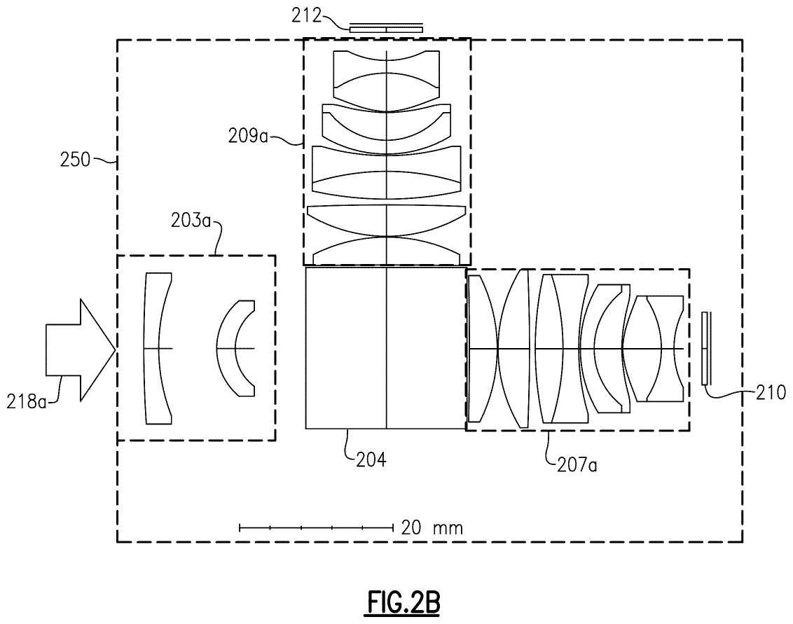

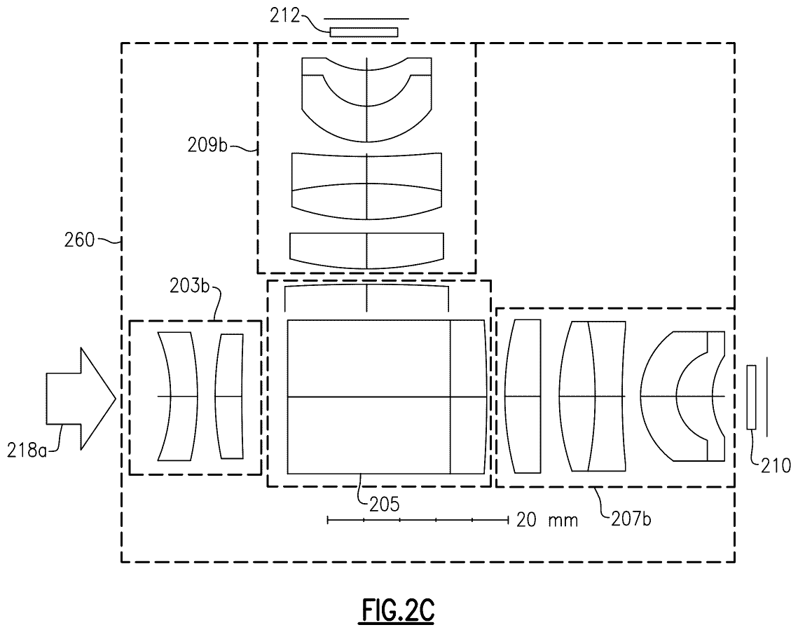

FIG. 2A is a block diagram illustrating an example imaging system 102 for generating digital images of a scene. In some cases, the imaging system 102 can generate a modified digital image that includes a significantly smaller number of NIR spots (e.g., NIR laser spots) associated with light received from a scene that includes one or more sources of NIR light (e.g., NIR lasers). In some cases, the imaging system 102 includes an optical system 220 (also referred to herein as an optical subsystem 220), at least two image sensors 210, 212, and a control and processing system 222. The optical system 220 receives light from the scene forms a first image on the first image sensor 210 and a second image on the second image sensor 212. In response to formation of the first and second images, the first and the second image sensors 210, 212, generate a first and a second image signal 214, 216 respectively, and transmit the first and the second image signals 214, 216 to the control and processing system 222.

In some cases, the first image signal 214 includes or is a first digital image associated with the first image of a scene formed on the first image sensor 210, and the second image signal 216 includes or is a second digital image associated with the second image of the same scene formed on the second image sensor 212. In some cases, the first image can have a spectral intensity distribution different from that of the second image but be other otherwise identical to the second image (e.g., have the same magnification and capture the same features of the scene).

In some examples, the first and the second image signals 214, 216, comprise electrical signals carrying information (e.g., digital information) usable for generating the first and the second digital images, respectively.

The control and processing system 222 uses the first and the second image signals 214, 216 to generate a third image signal 226. The third image signal 226 can be a modified digital image sent to a navigation system or displayed by a user interface of vehicle 100. The third image signal 226 can be an electrical signal carrying information (e.g., digital information) usable for generating the modified digital image. In some cases, generating the modified digital image can involve removing a distinct bright spot, which appears on both the first and the second digital images, from the first digital image when a brightness level of the bright spot is greater on the second digital image compared to the first digital image.

In some implementations, the control and processing system 222 can transmit the third image signal 226 to a display system that uses the third image signal to generate an image viewable via a user interface. Additionally, or alternatively, the control and processing system 222 can transmit the third image signal 226 to a navigation system that uses at least the third image signal for navigation in an environment. In some examples, the navigation system uses the third signal in combination with signals received from a lidar system for navigation in the environment. The lidar system 106, the imaging system 102, and the navigation system can be mounted on a single vehicle 100 (e.g., an AV) and navigation in the environment can include detecting objects in the environment and determining their position and velocity with respect to the vehicle.

In some implementations, the control and processing system 222 can use the first and the second image signals 214, 216 to identify NIR spots (e.g., laser spots) generated by a NIR source (e.g., a lidar system) of the vehicle, or another vehicle in the scene.

In some examples, the control and processing system 222 first processes the first and the second image signals 214, 216, to generate a first and a second digital image, and then compare the first and the second images to identify the NIR spots. For example, the control and processing system 222 can identify NIR spots 129 and 127, which are generated by light emitted from a light source and/or lidar system of an incoming vehicle (e.g., light source 124 and/or lidar system 122 of the vehicle 120), and/or the NIR spots 111, and 115 generated by reflections of light emitted from a light source 104 and/or lidar system 106 of the vehicle 100.

In some cases, the first and the second image sensors 210, 212, can have substantially similar or identical spectral responses. In some examples, the first and the second image sensors 210, 212 can be silicon-based sensors. In some examples, the first and the second image sensors 210, 212, can be both complementary metal-oxide-semiconductor (CMOS) sensors with a peak responsivity in the visible wavelength range. In some examples, the first and the second image sensors 210, 212 can sensitivity from 400 nm to 1100 nm. In some embodiments, the first and the second image sensors 210, 212 can be a zoom-capable imagers capable of generating a zoomed image that can be smaller or larger compared to an image projected on the corresponding sensor. In some embodiments a difference between a peak response wavelength of the first image sensor and a peak response wavelength of the second image sensor can be less than 2 nm, less than 5 nm, less than 10 nm, or less than 20 nm. In some embodiments, an overlap between a response or sensitivity bandwidth of the first image sensor and the second image sensor can be greater than 70%, greater than 80%, greater than 90%, or larger values.

In some embodiments, the optical system 220 can comprise, an objective lens group 202, a dichroic beam splitter (e.g., a dichroic prism) 204, a first imaging lens group 206, and a second imaging lens group 208. The objective lens group 202 receives light rays 218a from a scene or an environment via the entrance opening 224, transforms the received light rays, and transmits the transformed light rays 218b to the dichroic beam splitter (e.g., dichroic prism) 204. In some cases, the entrance opening 224 includes a shutter (e.g., a mechanical or electro-optical shutter) through which light enters the optical system 220 from a scene. The imaging control signal can open the shutter to allow formation of images on the VIS and NIR image sensors 210, 212, or close the shutter to block light from entering the optical system 220.

In some examples, received light rays 218a enters the imaging system 102 via the entrance opening 224, are intercepted by a first lens of the objective lens group 202, and the transformed light rays 218b include light rays exiting the last lens of the objective lens group 202. The objective lens group 202 generates the transformed light rays 218b by redirecting one or more of the light rays that are intercepted by a first lens and outputting the redirected light rays via the last lens.

The dichroic beam splitter 204 redirects a first portion 232 of the transformed light rays 218b received from the objective lens group 202 toward the first imaging lens group 206, and a second portion 230 of the transformed light rays 218b toward the second imaging lens group 208. The first portion 232 of the transformed light rays 218b can include light having wavelengths within a first wavelength range (or bandwidth) and the second portion 230 of the transformed light rays 218b can include light having wavelengths within a second wavelength range different from the first wavelength range. In some cases, the first wavelength range partially overlaps with the second wavelength range. In some other cases, the first and the second wavelength ranges are non-overlapping wavelength ranges. The first wavelength range can at least partially overlap with the response spectrum of the first imaging sensor 210 and the second wavelength range can at least partially overlaps with the response spectrum of the second imaging sensor 212. In some cases, the first wavelength range

In some examples, the first and the second wavelength ranges are VIS and NIR ranges, respectively. Accordingly, in some examples, the dichroic beam splitter 204 can transmit light having wavelengths from 400 nm to 700 nm to the first imaging lens group 206 and redirect (e.g., reflect) light having wavelengths from 700 nm to 1100 nm or 700 nm to 1700 nm, to the second imaging lens group 208. As such, in these examples, the first portion 232 of the transformed light rays 218b received by the first imaging lens group 206 can have a wavelength distribution within VIS wavelength range (e.g., having a mean value within VIS wavelength range), and the second portion 230 of the transformed light rays 218b received by the second imaging lens group 208 can have a wavelength distribution within NIR wavelength range(e.g., having a mean value within NIR wavelength range).

In some examples, one or more optical surfaces of the first imaging lens group 206 can include an antireflection layer or coating configured to reduce or potentially eliminate Fresnel reflection at least in a portion of the first wavelength range (e.g., VIS wavelength range), and one or more optical surfaces of the second imaging lens group 208 can include an antireflection layer or coating configured to reduce or potentially eliminate Fresnel reflection at least in a portion of the second wavelength range (e.g., NIR wavelength range).

In some examples, one or more optical surfaces of the first imaging lens group 206 can include coating or layers configured to selectively transmit at least a portion of light having wavelengths within the first wavelength range (e.g., VIS wavelength range) and reject/or block light having wavelengths within the second wavelength range (e.g., NIR wavelength range). In some examples, one or more optical surfaces of the second imaging lens group 206 can include coating or layers configured to selectively transmit at least a portion of light having wavelengths within the second wavelength range (e.g., NIR wavelength range) and reject/or block light having wavelengths within the first wavelength range (e.g., VIS wavelength range).

The first imaging lens group 206 further transforms the first portion 232 of the transformed light rays 218b to form a first image on the first image sensor 210, and the second imaging lens group 208 further transforms the second portion 230 of the transformed light rays 218b to form a second image on the second image sensor 212. The first and the second lens groups 206/208 can be substantially identical lens groups or can have identical optical transformation properties (e.g., redirect a given bundle of input rays the same way, have identical linear and angular magnifications, and the like). As such the first and the second images formed on the first and the second images sensors 210/212 can be images of the same portion of the scene and with the same magnification. In some cases, the first and the second images formed on the first and the second images sensors 210/212 can be images of the same portion of the scene and with the same magnification while having different spectral characteristics (due to spectral properties of the dichroic beam splitter 204 and possibly coating applied to a component in one or both optical trains). For example, the first image can be formed by light having a wavelength distribution within VIS spectral range (e.g., having a mean value within VIS wavelength range), and the second image can be formed by light having a wavelength distribution within NIR spectral range (e.g., having a mean value within NIR wavelength range). As such when the first and the second image sensors 210, 212 have similar or substantially identical spectral responses, features generated by NIR light (e.g., from a lidar sensor) can have a greater brightness level in a digital image of a scene generated by the second image sensor 212 compared to a digital image of the same scene generated by the first image sensor 210.

The imaging system 102 can include a housing that includes the entrance opening 224 configured to admit light from the scene or environment and houses the optical system 220, the image sensors 210, 212. In some implementations, at least a portion of the control and processing system 222 can be included in the housing.

In some cases, the control and processing system 222 can include a memory and at least one processor configured to execute the machine-readable instructions stored in the memory. The control and processing system 222 can include a field programmable gate array (FPGA), a memory unit, a digital signal processing unit, an internal wireless transceiver.

In some implementations the control and processing system 222 can synchronize the first and the second image sensors to output image signals associated with the same scene and at the same time. In some implementations the control and processing system 222 can process the VIS image signals 214 and the NIR image signals 216 such image signals associated with the same scene and at the same time are processes together (e.g., compared together).

The capability of the optical system 220 for generating two images of the scene with substantially equal magnifications (e.g., using substantially identical sequence of optical elements), combined with synchronized generation and processing of the image signals, allows the control and processing system 222 to make a direct comparison between respective portions of the two digital images received from VIS and NIR image sensors and generate a modified digital image. In some examples, the direct comparison can include pixel-to-pixel comparison, comparing shapes and/or sizes or respective regions on the two images.

In some examples, the first and the second image sensors 210, 212, can have different spectral responses. For example, the first image sensor 210 can be more sensitive within a first wavelength range and the second image sensor 212 can be more sensitive within a second wavelength range. In some cases, the first wavelength range partially overlaps with the second wavelength range. In some other cases, the first and the second wavelength ranges are non-overlapping wavelength ranges. In some examples, the first image sensor 210 can be a VIS image sensor and the second image sensor 212 can be a NIR image sensor. Accordingly, the first wavelength range can be a VIS wavelength range and the second wavelength range can be a NIR wavelength range. In some examples, a difference between a peak response wavelength of the first image sensor 210 and the second image sensor 212 can be more than 10 nm, more than 30 nm, more than 50 nm, more than 100, more than 500 nm, but less than 2000 nm. In some implementations, the VIS image sensor can be any type of sensor that can generate an image based on visible light. For example, the visible image sensor can be a charge coupled display (CCD) sensor or a CMOS sensor or any other type of sensor capable of generating a user-visible image from visible light. In some implementations, the NIR image sensor 212 can be any type of sensor that can generate an image based on IR or NIR light. For example, the NIR image sensor 212 can be an image sensor based on compound semiconductor material including an IR focal-plane array.

Although shown as a dichroic beam splitter 204, it will be understood that other prisms can be used as the beam splitter. In some cases, the beam splitter can generate two images having similar or the same spectral properties with same or different intensities. For example, when the peak spectral response of the first and the second image sensors 210, 212 are sufficiently different or the second image sensor 212 has very low sensitivity to VIS wavelengths, the dichroic beam splitter 204 can be replaced by a non-dichroic beam splitter (e.g., a spectrally neutral beam splitter) having a splitting ratio between 95/5 to 50/50 within a spectral range at least partially overlapping with the NIR and VIS spectral ranges. In these examples, the splitting ratio of the beam splitter can be selected based on the spectral sensitivity of the first and the second image sensors 210, 212 to facilitate identification of NIR spots in the second digital image generated by the NIR image sensor 212.

It should be understood, in various implementations, one or a combination of components and/or features including but not limited to dichroic beam splitting, coatings or filters having wavelength selective transmission or reflection properties, and imaging sensors having different spectral responses, can be used to provide a first image signal 214 (e.g., a VIS image signal) comprising a first digital image of a scene and a second image signal 216 (e.g., a NIR image signal) comprising a second digital image of the same scene, where signatures of NIR light from the scene on the second digital image are brighter than the respective signatures on the first digital image.

FIG. 2B is a block diagram illustrating an example arrangement of optical components in an optical system (or optical subsystem) 250 that can be used by the imaging system 102 shown in FIG. 2A. In some embodiments, the optical system 250 can have a medium size field of view (FOV). The objective lens group 203a of the optical system 250 includes two singlet lenses. The first and second imaging lens groups 207a, 209a, of the optical system 250, each include three doublet lenses and a singlet lens. In some cases, the single lens can be in contact with or attached to the dichroic beam splitter 204.

FIG. 2C is a block diagram illustrating another example arrangement of optical components in an optical system (or optical subsystem) 260 that can be used by the imaging system 102 shown in FIG. 2A. In some embodiments, the optical system 260 can have a narrow field of view (FOV). The objective lens group 203b of the optical system 250 includes two singlet lenses. The first and second imaging lens groups 207b, 209b, of the optical system 260, each include two doublet lenses and two singlet lenses where the singlet lens that receives light from the objective lens group is bonded (e.g., pre-bonded) to a dichroic beam splitter. In some examples, using dichroic beam splitter 205 with pre-bonded singlet lenses can facilitate the optical alignment of the optical system 260 and improve its accuracy. In some cases, the dichroic beam splitter 205 includes at least one pre-bonded singlet lens (e.g., a single lens in the first lens group 207b). In some cases, the dichroic beam splitter 205 includes two pre-bonded singlet lenses in the first and second imaging lens groups 207b, 209b, respectively. Additionally, pre-bonding the singlet lenses to the dichroic beam splitter 205 can reduce or potentially eliminate Fresnel reflections (e.g., by eliminating or reducing the air gap between the singlet lens and the dichroic beam splitter) and thereby improve optical transmission to from the objective lens group 203b to the lenses in each of the imaging lens groups.

### Synchronous Operation of the Imaging System and Lidar

In some cases, an optical probe beam emitted by a lidar system (e.g., lidar system 106, 122) includes an optical probe signal that includes a distinct temporal variation of an optical property (e.g., amplitude, phases, frequency, polarization) of the optical probe beam (e.g., laser beam) emitted by the lidar system. The lidar system detects an object and/or determines a distance/velocity of the object with respect to lidar system, by illuminating the object with the optical probe signal and measuring a delay between emission of the optical probe signal and reception of the corresponding reflected optical signal from the object.

In some examples, the optical probe signal can be a coded such that its can be distinguished from other optical probe signals emitted by the same or other lidar systems. A coded optical probe signal can include one more optical pulses, which are coded using, for example, a temporal, amplitude, phase, or polarization coding scheme. In some cases, characteristics of a coded optical probe signal can be used as a unique identifier for identifying the optical probe signal emitted by a lidar. Characteristics of a coded optical probe signal include but are not limited to: relations (e.g., ratios, or differences) between delays between two or more pairs of optical pulses, intensities (e.g., optical intensities) of one or more optical pulses, relations between intensities of two or more optical pulses, and/or number of optical pulses in a sequence of optical pulses. In some cases, characteristics of a pulse sequence can include other parameters. In some cases, the unique identifier can be used to distinguish the optical probe signals emitted by different lidar systems. In some cases, the characteristic of a coded optical probe signal can be used by an imaging system of another vehicle to identify the lidar system that emits such coded optical probe signals. In some examples, the imaging system can determine a type of make of the lidar system based at least in part on a characteristic of a coded optical probe signal emitted by the lidar system.

In some implementations, a coded optical probe signal, can include a plurality of periodically emitted optical pulse trains (including two or more optical pulses). In some examples, an individual optical pulse train includes a number of substantially identical and sequentially emitted optical pulses having similar intensities and pulse widths. In some cases, the optical pulses can be equally spaced in time domain where each optical pulse is emitted with a fixed delay after emission of a pulse immediately emitted before that optical pulse.

In some implementations, the control and processing system 222 can synchronize the imaging system 102 with the lidar system 106 to separately receive and process image signals (VIS and/or NIR image signals 214/216) in the presence and absence of optical probe beams emitted by the lidar system 106. Such synchronized operation can be used to distinguish light emitted by a light source other than the lidar system 106 (e.g., lidar system 122, light source 124, and light source 136).

In an embodiment, the control and processing system 222 can be in communication with the lidar system 106 via a wired or wireless link through which it receives synchronization signals from the lidar system 106. The control and processing system 222 can use the synchronization signal received from the lidar system 106, to generate an imaging control signal. In various implementations, the imaging control signal can control an imaging period during which: light is enters the optical system 220, the VIS and NIR image signals 214/216 are generated by the VIS and NIR image sensors 210/212, and/or the control and processing system 222 processes the received VIS and NIR image signals 214/216. For example, the imaging control signal can initiate an imaging period by opening a shutter, activating the VIS and NIR image sensors 210/212, and/or cause the control and processing system 222 to process the received image signals 214/216. Accordingly, the imaging control signal can terminate an imaging period by closing the shutter, deactivating the VIS and NIR image sensors 210, 212, and/or suspending the image processing in the control and processing system 222.

In some examples, the control and processing system 222 can include a control sub-system that controls the operation of the imaging system 102, and a processing sub-system that receives the image signals from image sensors and generates modified digital images. In some such examples, the control sub-system receives the synchronization signals, generates the imaging control signals, and transmits them to the processing sub-system. In some examples, the control and processing sub-systems can be included in a single enclosure or they can be included in separate enclosures at different positions. In some examples, the imaging control signals can be generated by a central control system of vehicle 100 that controls the operation of the lidar system 106 and the imaging system 102.

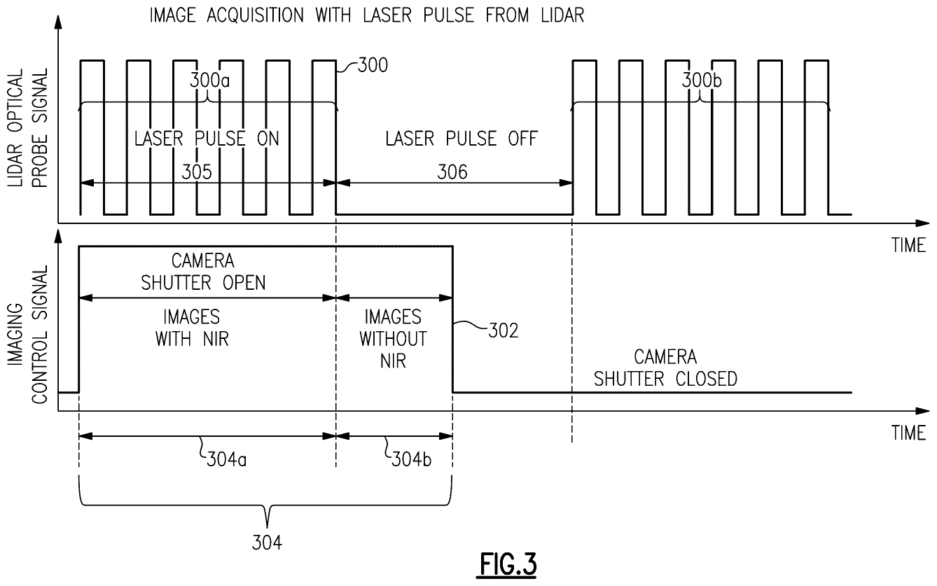

FIG. 3 is a diagram illustrating an example temporal alignment between a portion of an optical probe signal 300 emitted by the lidar system 106 and a portion of an imaging control signal 302 generated by the control and processing system 222, when the lidar system 106 is synchronized with the imaging system 102 (e.g., using a synchronization signal). The optical probe signal 300 can include periodically emitted pulse trains where each pulse train includes a plurality of optical pulses (in this case, 6 pulses). In the example shown, the portion of the optical probe signal 300 includes a first pulse train 300a emitted during a first time interval 305, a second time interval 306 after the first time during which no light is emitted by the lidar system 106, a second optical pulse train 300b emitted during a third time interval after the second time interval. In some examples, the optical probe signal 300 can be a periodic signal having a period substantially equal to the sum of the first and the second time intervals 305, 306. In some such examples, the optical pulse trains emitted during different periods of the optical probe signal 300, can be substantially identical (e.g., having, the same number of pulses, same pulse shapes, same inter-pulse delays, and same pulse amplitudes). The imaging control signal 302 is temporally aligned with the optical probe signal 300 such that an imaging period 304 overlaps at least partially with both the first and the second time intervals 305, 306.

In some cases, the imaging period starts when the amplitude of the imaging control signal 302, provided to the optical system 220 and/or the image sensors 210, 212, is above a threshold value, and ends when the amplitude of the imaging control signal 302 falls below the threshold value. As mentioned above, the imaging control signal 302 can control the entrance opening 224, the image sensors 210/212, and/or the processing of the image signals 214/216 by the control and processing system 222. During the imaging period 304, a shutter of the optical system 220 is open, the image sensors 210/212 transmit image signals 214/216 to the control and processing system 222, and the control and processing system 222 processes the received image signals 214, 216. The imaging control signal 302 can terminate the imaging period (e.g., after the imaging period 304), by closing the shutter, disconnecting the image sensors 210, 212 from the control and processing system 222, and/or by causing the control and processing system 222 not to process image signals 214, 216 received from the image sensors 210, 212.

In some cases, the first and the second portions 304a, 304b of the imaging period 304 can be smaller than the first and the second time intervals 305, 306 respectively. In some cases, the image control signal can stay below the threshold level during emission of one or more pulse trains and goes above the threshold level to activate the imaging system 102 for another cycle of imaging where image signals are received during an imaging period partially overlapping with at least one optical pulse train and at least one time interval between emission of the optical pulse train and a subsequent optical pulse train.

In the example shown, the imaging period 304 consists of a first portion 304a that is substantially equal to the first time interval 305, during which the first pulse train 300a is emitted, and a second portion 304b that partially overlaps with the second time interval 306, during which the lidar system 106 does not emit light. As such, under the control of the imaging control signal 302, the control and processing system 222 can separately process image signals and generate digital images in the presence and absence of optical pulses emitted by the lidar system 106. In some cases, the control and processing system 222 can be configured to separately process the digital images generated by the image signals received during the first and second time intervals 305, 306 to generate digital images, and compare the resulting digital images to extract information usable for lidar system identification, vehicle identification, and/or generating modified digital images.

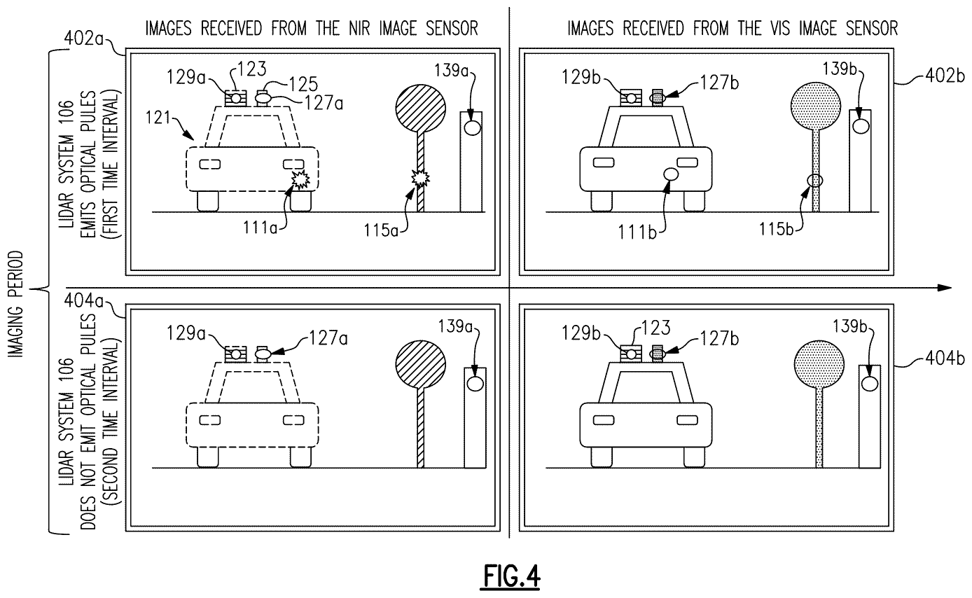

FIG. 4 is a diagram illustrating examples of digital images generated using first portions of the VIS and NIR image signals 214, 216 generated in the presence of the lidar probe signals emitted by a lidar system 106, and second portions of the VIS and NIR image signals 214, 216 generated in the absence of the lidar probe signals emitted by a lidar system 106.

Digital images 402a and 404a are generated by the first and the second portions of the NIR image signals 216, respectively. Digital images 402b and 404b are generated by the first and the second portions of the VIS image signals 214, respectively.

The digital images 402a, and 402b, which are generated during the first time interval 305 (first portion 304a of the imaging period 304) by the NIR and VIS image signals, respectively, include NIR spots associated with reflections of light emitted by the lidar system 106 and all other sources of NIR light in the scene. However, due to higher sensitivity of the NIR image sensor 212, the NIR spots 111a, 115a, 129a, 127a and 139a in the digital image 402a are much brighter than the respective NIR spots 111b, 115b, 129b, 127b and 139b in the digital image 402b.

The digital images 404a, and 404b, which are generated during the second portion 304b of the imaging period 304 by the NIR and VIS image signals, respectively, do not include NIR spots 111a, 115a, 111b, 115b, 129b, generated by reflections of light emitted by the lidar system 106. Due to higher sensitivity of the NIR image sensor 212, the NIR spots 129a, 127a and 139a in the digital image 404a are much brighter than the respective NIR spots 129b, 127b, and 139b in the digital image 404b.

In some embodiments, the control and processing system 222 can use the digital images 402a, 402b, 404a, and 404b, to identify the NIR spots and distinguish the NIR spots associated with the lidar system 106 from those associated with the lidar system 122. For example, a comparison between the digital images 402a and 402b can be used to verify that certain distinct regions on the digital image 402b (generated by the VIS image sensor 210) are actually NIR spots and not some artifacts. As another example, a comparison between the digital images 402a and 404a can be used to distinguish the NIR spots 129a, 127a, and 139a, emitted by sources other than the lidar system 106 from the NIR spots 111a and 115a that are reflections of the optical probe beams emitted by the lidar system 106. In some implementations, the control and processing system 222, can further distinguish the NIR spots 129a/b generated by the lidar system 122 from the NIR spots 127a/b and 139a/b, based at least in part their temporal or spatial profile. For example, the intensity of the NIR spots 129a/b can change much faster than the intensity of the spots 127a/b and 139a/b.

In some implementations, once the NIR spot is identified as signature of light emitted by a lidar system (e.g., lidar system 122) other than the lidar system 106, which can be synchronized with the imaging system 102, the control and processing system can analyze the NIR spots 129a/b in one or more digital images received from one or both VIS and NI image sensor 210, 212, to identify a temporal and/or spatial pattern of the corresponding NIR light beams (e.g., light beam 128 emitted by the lidar system 122). For example, the lidar system 122 can emit one or more optical probe beams that each generate a distinct NIR spot on a digital image captured by the imaging system 102. In these examples, the NIR spots 129a/b can include several distinguishable sub-spots. The control and processing system 222, can analyze a distribution of the sub-spots to identify a characteristic spatial pattern.

Further, in some cases, each optical probe signal can include a time varying optical probe signal. for example, the optical probe signal can include a series of periodically emitted optical pulse trains. In some cases, the control and processing system 222, can analyze temporal variation of a NIR spot or several NIR sub-spots to identify a characteristic temporal pattern. In some implementations, the control and processing system 222, compares the identified characteristic temporal and/or spatial patterns with reference temporal and/or spatial patterns stored in a non-transitory memory of the imaging system 102 (or other systems onboard vehicle 100). In response to identifying a close match with a reference temporal and/or a spatial pattern, the control and processing system 222 can determine a type. Model, and/or make of the corresponding lidar system (e.g., the lidar system 122).

In some cases, the control and processing system 222 can use the determined model, and/or make of the corresponding lidar system and vehicle reference data stored in the non-transitory memory to determine a profile, a model, and/or a make of the vehicle (e.g., the vehicle 120) on which the lidar system is mounted.

In some embodiments, the image formed on the second image sensor 212 of the imaging system 102 can be used for range finding. In these embodiments the second image sensor 212 can include be a high sensitivity detector array configured for detecting reflection of laser beams (e.g., IR laser beams) emitted by an optical emission system of the vehicle 100 (e.g., an optical emission system of the lidar system 106 or another optical emission system). For example, the second image sensor 212 can be a two-dimensional (2-D) silicon photomultiplier (SiPM) array, or a 2D single-photon avalanche photodiode (SPAD) array. In some cases, the second image sensor 212 can generate a signal indicative of one or more laser spots associated with laser beams emitted by the optical emission system of the vehicle 100 and transmit the signal to the control processing system 222 (or another processing system of the vehicle 100), to determine a velocity and/or a distance of an object (e.g., the incoming vehicle 120) from the vehicle 100. As such, in some implementations, the imaging system 102 can be configured to serve as a detector of a lidar system while generating digital images of the surrounding environment.

### Example Processes Used by an Imaging System

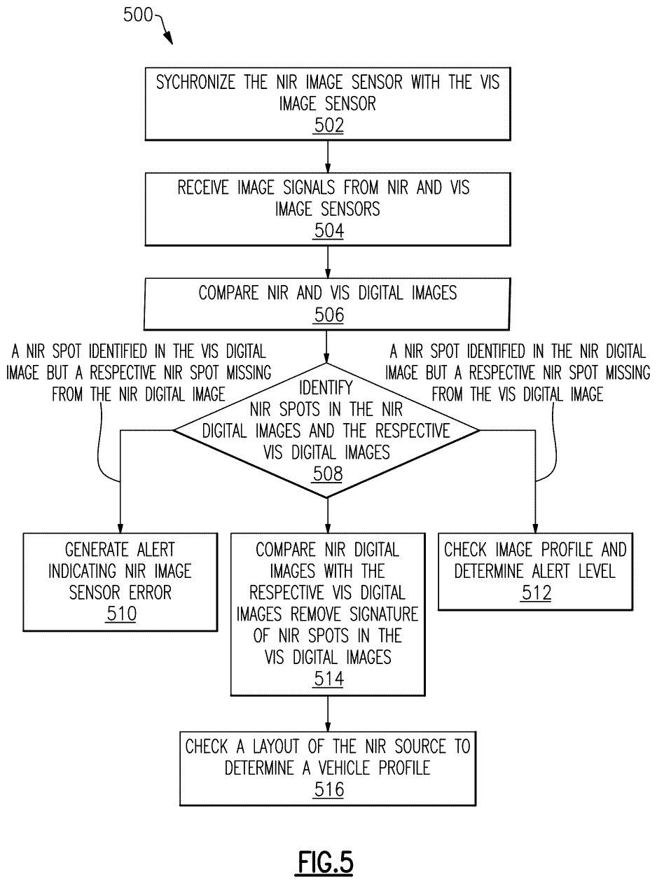

FIG. 5 is a flow diagram illustrating an example process 500 for reducing or potentially eliminating NIR spots from the VIS image, generating alerts indicating failure of an image sensor (e.g., the NIR image sensor 212), and generating a warning indicating the potential presence of an object not captured by the visible image sensor, in the scene. Additionally, in some embodiments, the imaging system 102 can determine a profile of a vehicle (e.g., an AV) based on NIR spots identified on a NIR and/or VIS digital image.

In some embodiments, the process 500 can be performed, at least partially, by the control and processing system 222 of the imaging system 102. In some cases, a portion of the process 500 can be performed by a processing system separate from the control and processing system 222 (e.g., another processing system of the vehicle 100).

At block 502, the control and processing system 222 synchronizes the VIS image sensor 210 with the NIR image sensor 212. In some examples, the control and processing system 222 can synchronize the transmission or reception of the VIS and NIR image signal 214, 216 from the VIS and NIR image sensors 210, 212. In some cases, the digital images obtained from synchronized VIS and a NIR image sensors 210, 212 correspond to two images of the same portion of a scene generated at the same time (one on the VIS image sensor 210 and one on the NIR image sensors 212) or within a threshold amount of time (e.g., within 1, 10, 100 milliseconds, etc.).

At block 504, the control and processing system 222 receives VIS and NIR image signals 214, 216 from the VIS and NIR image sensors 210, 212. In some cases, the imaging system 102 and the lidar system 106 of the vehicle 100 can be synchronized such that the received NIR and VIS image signals 214, 216, can include image signals received in the presence and absence of optical pulses emitted by the lidar system 106. In such cases, the lidar optical probe signal can be aligned with respect to an imaging control signal, which controls the imaging system 102, according to the example shown in FIG. 3.

At block 506, the control and processing system 222, compares the NIR and VIS digital images corresponding to the VIS and NIR image signals received at block 602.

At decision block 508, the control and processing system 222 NIR identifies NIR spots in the NIR and VIS digital images based on the comparison made at block 506 and determines whether a NIR spot identified one image sensor is missing in the other digital image. In some examples, identifying NIR spots in the NIR and VIS digital images can comprise identifying a first NIR spot on the NIR digital image at a position with respect to the NIR digital image, and a second NIR spot on the VIS digital image at the same position with respect to the VIS digital image.

If at the decision block 508 the control and processing system 222 determines that at least one NIR spot identified on the NIR digital image is missing from the VIS digital image, the process proceeds to block 512, where the control and processing system 222 checks profile of the VIS digital image and determines an alert level. In some cases, the control system 222 can determine the alert level based at least in part on a difference between the NIR and VIS digital images. In some examples, the difference can comprise a number of NIR spots that are present in the NIR digital image but are missing from the VIS digital image. Subsequently the control system 222 can generate an alert message indicative of presence of one or more objects in a scene shown in the VIS digital image. In some cases, the alert can include an indication of an approximate location of such objects in the scene.

If at the decision block 508 the control and processing system 222 determines that at least one spot (e.g., a NIR spot) identified on the VIS digital image is missing from the NIR digital image, the process proceeds to block 510, where the control and processing system 222 generates an alert indicating possible NIR image sensor error. In some implementations, when the NIR image does not include a spot corresponding to a spot detected on the VIS digital image, the spot may have been generated by a visible light or light having a wavelength that is highly attenuated before reaching the NIR image sensor. As such, to verify that the absence of a spot on an NIR digital image is due a NIR sensor malfunction, in some implementations the imaging system 102 can include an auxiliary NIR light source (e.g., NIR Light emitting diode) configured to direct NIR light towards the entrance opening 224 and/or the objective lens group for checking the status of the NIR path sensor. For example, when the control and processing system 222 determines that at least one spot (e.g., a NIR spot) identified on the VIS digital image is missing from the NIR digital image, the control and processing system 222 can activate the auxiliary NIR light source and search for a signature of the NIR light generated by the auxiliary light source on a digital image generated by the NIR image sensor. When such a signature is not found, the control and processing system 222 generates an alert indicating possible NIR image sensor error.

If at the decision block 508 the control and processing system 222 determines that the digital images include corresponding NIR spots (e.g., the NIR spots in one image are found in the other image and vice versa), the process proceeds to block 514 where the control and processing system 222 generates a third digital image (e.g., a modified digital image having fewer laser or bright spots, a clean digital, or spot-free digital image) by removing the identified NIR spots from the VIS digital image.

In some cases, when the imaging system 102 and the lidar system 106 are synchronized, after block 508, the process proceeds to block 516 where the control and processing system 222 checks a layout of the NIR spots that are not associated with the lidar system 106 to identify a light source (e.g., the lidar system 106) and determine a profile of a vehicle (e.g., vehicle 120) that carries the light source.

Fewer, more, or different blocks can be included in the process 500. For example, in some cases, at block 506, in addition to NIR spots, the control and processing system 222 can identify a distinct region on a digital image obtained from the VIS image sensor 210, search for the signature or counterpart of the distinct region on a digital image obtained from the NIR image sensor 212, and if such signature is not found, generate an alert indicating a malfunction of the NIR image sensor 212. Further, the system can identify a distinct region on a digital image obtained from the NIR image sensor 212, search for the signature or counterpart of the distinct region on a digital image obtained from the VIS image sensor 210, and if such signature is not found, generate a warning indicating that an object not observed on the VIS digital image, can be present in the scene.

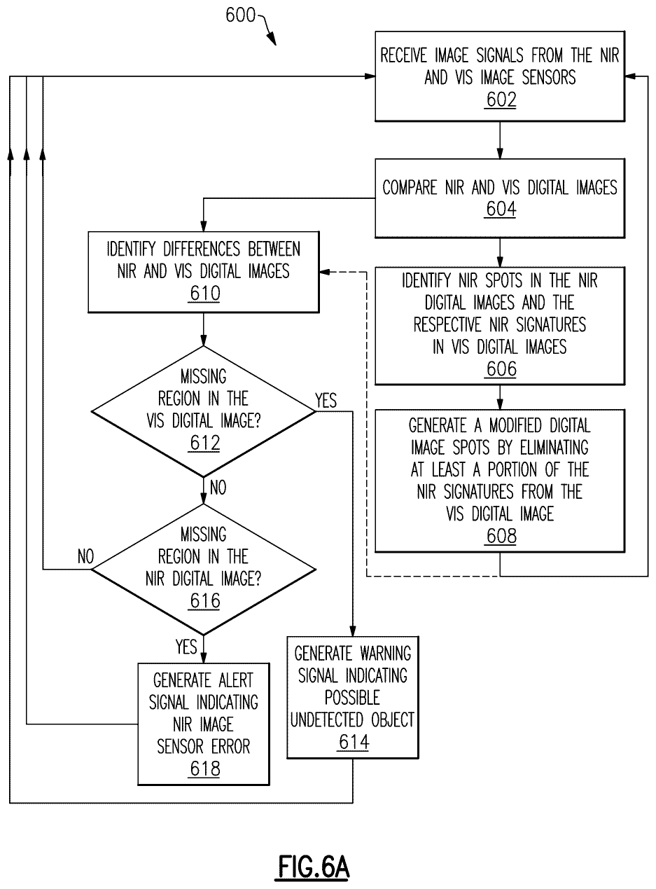

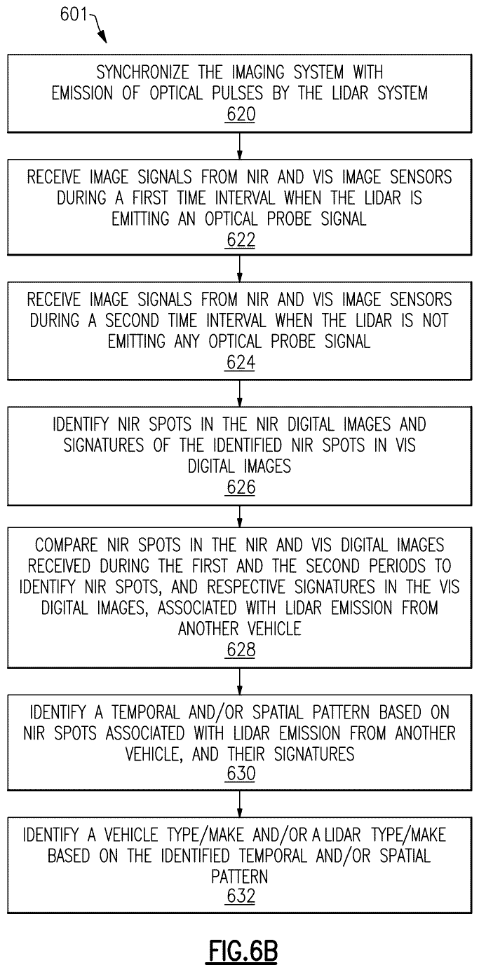

FIG. 6A is a flow diagram illustrating a process 600 for reducing bright spots (e.g., laser spots) on a digital image obtained from the VIS image sensor 210, which are associated with NIR light, to generate a modified digital image, and/or generating alerts when the signature of an image portion identified in a digital image obtained from one of the image sensors 212, 210 is missing from another digital image obtained from the other one of the sensors 212, 210. In some cases, the modified digital image can include fewer bright spots compared to the digital image obtained from the VIS image. In some such cases, the modified mage can be a spot-free or clean digital image. In various implementations, a number of bright spots in a modified image can be less than 30%, less than 20%, or less than 10% of the number of bright spots in the digital image obtained from the VIS image.

In some embodiments, the process 600 can be performed, at least partially, by the control and processing system 222 of the imaging system 102. In some cases, a portion of the process 600 can be performed by a processing system separate from the control and processing system 222 (e.g., another processing system of the vehicle 100).

At block 602, the control and processing system 222 receives image signals 214, 216 from the first and second image sensors 210, 212. In some examples, the first image sensor 210 can be a VIS image sensor and the second image sensor 212 can be a NIR image sensor. Accordingly, image signals received from the VIS image sensors 210 and NIR image sensor, are referred to as VIS image signal and NIR image signal.

At block 604, the control and processing system 222, compares the NIR and VIS digital images corresponding to the VIS and NIR image signals received at block 602. In some examples, the control and processing system 222 can compare the VIS and NIR digital images directly by comparing the respective portions of data carried by the VIS and NIR image signals 214, 216. In some other examples, the control and processing system 222 first generates the VIS and NIR digital images and then compares them on a pixel by pixel, or region by region basis. In some examples, the control and processing system 222 compares the NIR and VIS digital images by comparing properties (e.g., brightness level, contrast, and the like) of one or more pixels of the VIS digital image with those of the respective pixels in the NIR digital image. In some cases, the one or more pixels can form distinct regions on the VIS and NIR digital images. In some cases, the processing system 222 can compare normalized brightness of a portion of the VIS digital image with that of the respective portion of the NIR digital image. In some cases, a normalized brightness can be a brightness level normalized to a maximum brightness of the respective digital image.

At block 606, the control and processing system 222 NIR detects corresponding spots on the VIS and NIR digital images and identifies the signature of the NIR spots in the VIS digital images, based on the comparison made at block 604. In some examples, the control and processing system 222 identifies a first spot (e.g., a distinct spot and/or a bright spot) on the VIS digital image, determines a location of the first spot with respect to the VIS digital image pixel coordinates and a shape and/or size of the first spot, identifies a corresponding second spot on the NIR digital image using the determined location, and upon verifying that a shape and/or size of the second spot is similar (or substantially equal) to those of the first post and the second spot has a greater brightness than the first spot, identifies the first spot as a NIR spot or a laser spot on the VIS digital image. In some cases, the processing system 222 can identify an NIR spot on a NIR digital image and the signature of the NIR spot in the corresponding VIS image, by determining that a first normalized brightness of at least a first portion of the VIS digital image is smaller than a second normalized brightness of a respective portion of the NIR digital image.

At block 608, the control and processing system 222 generates a third digital image based on the NIR spots identified in the VIS digital image at block 606. The third image can be a modified digital image (e.g., a modified version of the VIS digital image). For example, the modified digital image can be a cleaner (e.g., with fewer or no NIR spots). The modified digital image can be generated by removing some or all of the identified NIR spots from the VIS digital image. In some cases, a normalized brightness of a portion of the modified digital image, corresponding to an identified NIR spot, can be smaller than the respective portion of the VIS digital image.

In some cases, the control and processing system 222 can remove an identified NIR spot by adjusting a parameter (e.g., brightness level and color composition) of one or more pixels corresponding to the NIR spot in the generate the modified digital image. In some cases, the control and processing system 222 can adjust the parameter based on a reference VIS digital image of the scene generated before or after generating the VIS digital image that is being modified such that the NIR spot is replaced with the portion of scene blocked by the NIR spot (e.g., a portion of the scene that would have been displayed in the absence of the NIR spot). In some such cases, the reference digital image can be the first digital image without the corresponding NIR image generated after the VIS digital image, or the first digital image that is generated before the VIS digital image and does not include the corresponding NIR image. In some implementations, the control and processing system 222 can generate the modified digital image by displaying the reference digital image (instead of modifying the VIS digital image having the NIR spot). In these cases, the reference digital image can be referred to as substitute digital image. In other words, in some examples, the processing system 222 can replace the VIS digital image that is being modified with a substitute digital image that includes the same portion of the scene that is included in the VIS digital image that is being modified. In some cases, at least one NIR spot (e.g., laser spot) that appears on the VIS digital image, which is being modified, can be missing from the substitute digital image. Advantageously, replacing the VIS digital image with the reference digital image can reduce time and processing power required for generating the modified digital image. In some cases, the NIR sensor 212 and the VIS image sensor 210 are synchronized such that the digital images generated by the NIR sensor 212 can be used to identify the NIR spots in the VIS image sensor 210 and a VIS image that includes a NIR spot can be accurately replaced by subsequent VIS digital image.

After block 608 the process 600 can return to block 602 to perform another cycle and refresh the modified digital image based on subsequent image signals received from the VIS and NIR image sensors 210, 212.

In some examples, after block 604, after block 604, the control and processing system 222, performs two processes in parallel. A first process including blocks 606 and 608 for generating a modified digital image, and a second process including blocks 610-618, for generating alerts and warning messages corresponding to malfunction or failure of an image sensor. In some embodiments, the control and processing system 222 can perform the first process including blocks 606 and 608 and second process including blocks 610-618, in series. For example, after block 608, the control and processing system 222 can perform blocks 610-618 and return to block 602 after block 618 or 614.

At block 610, the control and processing system 222 identifies differences between the VIS and NIR digital images. For example, the control and processing system 222 can find distinct regions on the VIS or NIR digital image and search for the respective region on the other digital image to determine whether all features of a digital are present in the other digital image and vice versa. The distinct region can correspond to an object, vehicle, or any feature in the scene captured by the imaging system 102.

At decision block 612, the control and processing system 222, determines whether a distinct region found on the NIR digital image is missing from the VIS digital image. In response to determining that at least one distinct region found on the NIR digital image is missing from the VIS image, the process proceeds to block 614, where the control and processing system 222 generates a warning signal indicating that an object or feature (e.g., a tree, a pedestrian, an obstacle, or the like) in the environment or the captured scene, can be missing from the image displayed on a user interface or a digital image transmitted to the navigation system for autonomous navigation. In some cases, the warning signal is transmitted to a user interface of vehicle 100, where it is provided to a user as a warning text, warning image, or warning sound. For example, the warning signal can be sent to the display system through which a user observes the modified digital image, and a textual or symbolic warning message can be superimposed on the modified digital image. After generating the warning signal at block 614, the process 600 returns to block 602 for another cycle of image evaluation and processing.

If at decision block 612, the control and processing system 222 determines that none of the distinct regions found on the NIR digital image is missing from the VIS image, the process proceeds to the decision block 616.

At decision block 616, the control and processing system 222, determines whether a distinct region found on the VIS digital image is missing from the NIR digital image. In response to determining that at least one distinct region found on the VIS digital image is missing from the NIR digital image, the process proceeds to block 618, where the control and processing system 222 generates an alert signal indicating that, the NIR image sensor may have failed. In some cases, the alert is transmitted to a user interface of vehicle 100, where it is provided to a user as text, image, or sound. For example, the alert signal can be sent to the display system through which a user observes the modified digital image, and a textual or symbolic alert message can be superimposed on the modified digital image. After generating the alert signal at block 618, the process 600 returns to block 602 for another cycle of image evaluation and processing.

If at the decision block 616, the control and processing system 222 determines that none of the distinct regions found on the VIS digital image is missing from the NIR image, the process 600 returns to block 602.

In some embodiments, the control and processing system 222 can synchronize the operation of the imaging system 102 and the lidar system 106 of vehicle 100, before performing the process 600. As described above with respect to FIG. 3, in these embodiments, an image signal received from the VIS image sensor or an image signal received from a NIR image sensor, each can include a first portion received when an optical pulse is being emitted by the lidar system 106 and a second portion received when no optical pulse is being emitted by the lidar system 106, respectively. Accordingly, first portions of the VIS and NIR digital images are obtained from the first portions of the corresponding image signals, and second portions of the VIS and NIR digital images are obtained from the second portions of the corresponding image signals. As such, in some cases, at block 604 the control and processing system compares the first portions of the VIS digital images with the first portions of NIR digital images, and the second portions of the VIS digital images with the second portions of NIR digital images.

FIG. 6B is a flow diagram illustrating a process 601 for identifying the NIR spots generated by the lidar system 106 on the images captured by the imaging system 102 and identifying a make or type of the lidar system 106.

At block 620 the control and processing system 222 operates the imaging system 102 in sync with the lidar system 106 to separately receive first portions of the VIS and NIR image signals when an optical probe beam is being emitted by the lidar system 106, and second portions of the VIS and NIR image signals when no optical probe beam is being emitted by the lidar system 106.

At block 622 the control and processing system 222 receives first portions of the image signals from VIS and NIR image sensors during a first time interval when the lidar system 106 is emitting a first optical pulse.

At block 624 the control and processing system 222 receives second portions of the image signals from VIS and NIR image sensors, during a second time interval when the lidar system 106 is not emitting a first optical probe beam (e.g., after emission of the first optical probe beam before emission of second optical probe beam after the first optical probe beam).

At block 626 the control and processing system 222 detects NIR spots in NIR digital images associated with the first and second portions of NIR image signals, and the identifies the signatures of the detected NIR spots in the respective VIS digital images associated with the first and second portions of VIS image signals.

At block 628 the control and processing system 222 compares the NIR spots and their signatures in the NIR and VIS digital images associated with the first portions of NIR and VIS image signals, with the NIR spots and their signatures in the NIR and VIS digital images associated with the second portions of NIR and VIS image signals, and identifies the NIR spots associated with light emitted by a light source (e.g., a lidar system) separate from the vehicle 100. For example, the control and processing system 222 can use the digital images associated with the first portions of NIR and VIS image signals to identify the NIR spots 129 (generated by the lidar system 122 of vehicle 120), 127 (generated by the light source 124 of the vehicle 120), or 139 (generated by the light source 136) in the image 130, and distinguish them from the NIR spots 111, 115 generated by the lidar system 106 of the vehicle 100.

At block 630 the control and processing system 222 determines a temporal and/or a spatial illumination pattern associated with the NIR spots identified at block 628.

In some cases, the temporal pattern includes a temporal variation of the brightness of a portion of image (e.g., a NIR spot) formed by the laser spots generated by optical probe beams of the lidar system 122 of the vehicle 120, over series of NIR and/or VIS digital images. In some cases, the temporal variation of brightness can be periodic.

In some cases, the spatial pattern includes a distinct pattern formed by the laser spots generated by optical probe beams of the lidar system 122 of the vehicle 120 in one or more NIR and/or VIS digital images.

In some cases, the spatial pattern can vary over time. For example, the spatial pattern can include a pattern, formed by the laser spots generated by optical probe beams of the lidar system 122 of the vehicle 120, that can be distinguished on the individual digital images of a series of NIR and/or VIS digital images obtained over a time interval. In these cases control and processing system can determine a temporal variation of a shape and/or brightness of the spatial pattern. In some cases, the shape and/or brightness of the spatial pattern can vary periodically.

At block 632 the control and processing system 222 identifies a type or make of the lidar system based at least in part on the temporal and/or a spatial pattern determined at block 632. In some examples, the control and processing system 222 identifies the type or make of the lidar system 122 by comparing a property of the determined spatial and/or temporal pattern (e.g., a period of change, a shape, or both) with reference data stored in a non-transitory memory of the control and processing system 222 or another non-transitory memory (e.g., a memory of a navigation system, or another system of the vehicle 100). In some examples, the control and processing system 222 can determine a make or a profile of the vehicle 120 on which the lidar system 122 mounted based at least in part on the determined make or type of the lidar system 122.

In some cases, the control and processing system 222 can identify a location of the lidar system of another vehicle (with respect to other vehicle) using the NIR spots associated with such lidar system. Subsequently the control and processing system 222 can identify a profile and/or a make of the other vehicle based on the identified location of the lidar system.

In various implementations, the NIR image sensor can be used for detecting objects in low light environments (e.g., when a level of visible light is not enough for identifying objects based on the digital images generated by the visible image sensor. For example, the control and processing system 222 can use a NIR light source (e.g., the light source 104) to illuminate a scene and detect objects using the NIR image sensor 212.

In some cases, an NIR digital image can include ghost artifacts that are not visible in the corresponding VIS digital image and vice versa. In some cases, a ghost response of the optical subsystem 220 can be characterized prior to deployment such that ghost artifacts that are present on one image sensor and missing from the other can be distinguished from NIR spots. In some such cases, the outcomes of such characterization (e.g., presence of a ghost artifact in a VIS and/or NIR image generated by the optical subsystem 220) are stored in a memory of the control and processing system 222 as optical characterization data. The control and processing system 222 can use optical characterization data to exclude Subsequently the ghost artifacts can be exclude or ignore the ghost artifacts when the comparing a VIS digital image with the corresponding NIR digital image (e.g., at blocks 506, 604, or 628).

### Vehicles With Lidar and Imaging System

In some aspects and/or embodiments, devices and methods described above can be used by an imaging system of an autonomous system included in a vehicle (e.g., an AV), to generate digital images for navigation and user information.

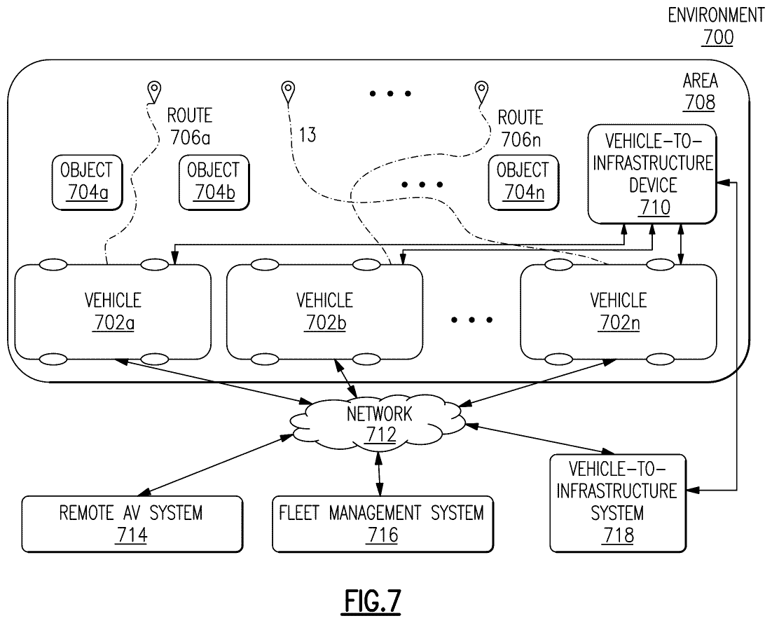

Referring now to FIG. 7, illustrated is example environment 700 in which vehicles that include autonomous systems, as well as vehicles that do not, are operated. As illustrated, environment 700 includes vehicles 702a-702n, objects 704a-704n, routes 706a-706n, area 708, vehicle-to-infrastructure (V2I) device 710, network 712, remote autonomous vehicle (AV) system 714, fleet management system 716, and V2I system 718. Vehicles 702a-702n, vehicle-to-infrastructure (V2I) device 710, network 712, autonomous vehicle (AV) system 714, fleet management system 716, and V2I system 718 interconnect (e.g., establish a connection to communicate and/or the like) via wired connections, wireless connections, or a combination of wired or wireless connections. In some embodiments, objects 704a-704ninterconnect with at least one of vehicles 702a-702n, vehicle-to-infrastructure (V2I) device 710, network 712, autonomous vehicle (AV) system 714, fleet management system 716, and V2I system 718 via wired connections, wireless connections, or a combination of wired or wireless connections.

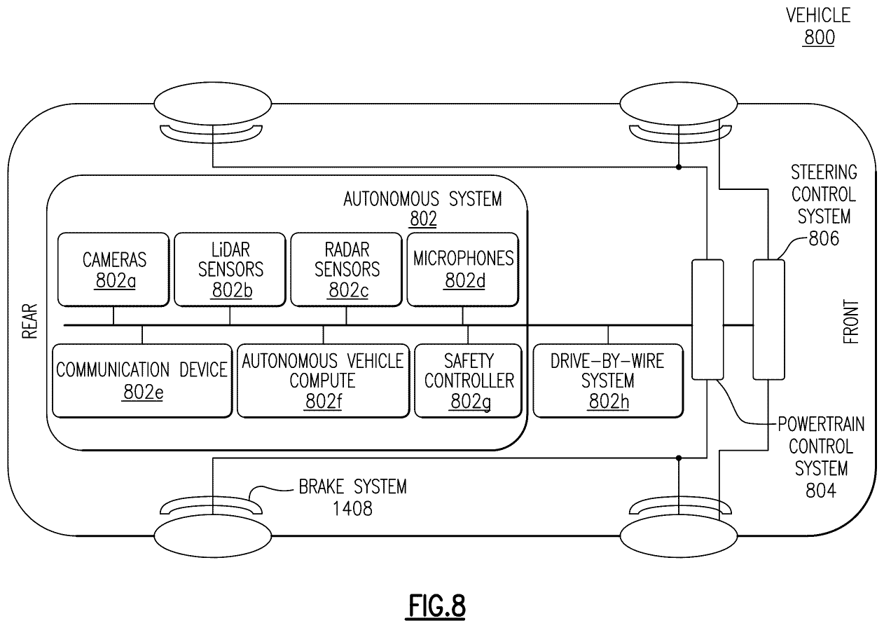

Vehicles 702a-702n (referred to individually as vehicle 702 and collectively as vehicles 702) include at least one device configured to transport goods and/or people. In some embodiments, vehicles 702 are configured to be in communication with V2I device 710, remote AV system 714, fleet management system 716, and/or V2I system 718 via network 712. In some embodiments, vehicles 702 include cars, buses, trucks, trains, and/or the like. In some embodiments, vehicles 702 are the same as, or similar to, vehicles 800, described herein (see FIG. 8). In some embodiments, a vehicle 800 of a set of vehicles 800 is associated with an autonomous fleet manager. In some embodiments, vehicles 702 travel along respective routes 706a-706n (referred to individually as routes 706 and collectively as route 706), as described herein. In some embodiments, one or more vehicles 702 include an autonomous system (e.g., an autonomous system that is the same as or similar to autonomous system 802).

Objects 704a-704n (referred to individually as object 704 and collectively as objects 704) include, for example, at least one vehicle, at least one pedestrian, at least one cyclist, at least one structure (e.g., a building, a sign, a fire hydrant, etc.), and/or the like. Each object 704 is stationary (e.g., located at a fixed location for a period of time) or mobile (e.g., having a velocity and associated with at least one trajectory). In some embodiments, objects 704 are associated with corresponding locations in area 708.

Routes 706a-706n (referred to individually as route 706 and collectively as routes 706) are each associated with (e.g., prescribe) a sequence of actions (also known as a trajectory) connecting states along which an AV can navigate. Each route 706 starts at an initial state (e.g., a state that corresponds to a first spatiotemporal location, velocity, and/or the like) and ends at a final goal state (e.g., a state that corresponds to a second spatiotemporal location that is different from the first spatiotemporal location) or goal region (e.g., a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 706 include a plurality of acceptable state sequences (e.g., a plurality of spatiotemporal location sequences), the plurality of state sequences associated with (e.g., defining) a plurality of trajectories. In an example, routes 706 include only high-level actions or imprecise state locations, such as a series of connected roads dictating turning directions at roadway intersections. Additionally, or alternatively, routes 706 can include more precise actions or states such as, for example, specific target lanes or precise locations within the lane areas and targeted speed at those positions. In an example, routes 706 include a plurality of precise state sequences along the at least one high level action sequence with a limited look ahead horizon to reach intermediate goals, where the combination of successive iterations of limited horizon state sequences cumulatively correspond to a plurality of trajectories that collectively form the high level route to terminate at the final goal state or region.

Area 708 includes a physical area (e.g., a geographic region) within which vehicles 702a-702n can navigate. In an example, area 708 includes at least one state (e.g., a country, a province, an individual state of a plurality of states included in a country, etc.), at least one portion of a state, at least one city, at least one portion of a city, etc. In some embodiments, area 708 includes at least one named thoroughfare (referred to herein as a “road”) such as a highway, an interstate highway, a parkway, a city street, etc. Additionally, or alternatively, in some examples area 708 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 702). In an example, a road includes at least one lane associated with (e.g., identified based on) at least one lane marking.

Vehicle-to-Infrastructure (V2I) device 710 (sometimes referred to as a Vehicle-to-Infrastructure or Vehicle-to-Everything (V2X) device) includes at least one device configured to be in communication with vehicles 702 and/or V2I infrastructure system 718. In some embodiments, V2I device 710 is configured to be in communication with vehicles 702, remote AV system 714, fleet management system 716, and/or V2I system 718 via network 712. In some embodiments, V2I device 710 includes a radio frequency identification (RFID) device, signage, cameras (e.g., two-dimensional (2D) and/or three-dimensional (3D) cameras), lane markers, streetlights, parking meters, etc. In some embodiments, V2I device 710 is configured to communicate directly with vehicles 702. Additionally, or alternatively, in some embodiments V2I device 710 is configured to communicate with vehicles 702, remote AV system 714, and/or fleet management system 716 via V2I system 718. In some embodiments, V2I device 710 is configured to communicate with V2I system 718 via network 712.

Network 712 includes one or more wired and/or wireless networks. In an example, network 712 includes a cellular network (e.g., a long term evolution (LTE) network, a third generation (3G) network, a fourth generation (4G) network, a fifth generation (6G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 714 includes at least one device configured to be in communication with vehicles 702a-702n, V2I device 710, network 712, fleet management system 716, and/or V2I system 718 via network 712. In an example, remote AV system 714 includes a server, a group of servers, and/or other like devices. In some embodiments, remote AV system 714 is co-located with the fleet management system 716. In some embodiments, remote AV system 714 is involved in the installation of some or all of the components of a vehicle, including an autonomous system, an autonomous vehicle compute, software implemented by an autonomous vehicle compute, and/or the like. In some embodiments, remote AV system 714 maintains (e.g., updates and/or replaces) such components and/or software during the lifetime of the vehicle.

Fleet management system 716 includes at least one device configured to be in communication with vehicles 702, V2I device 710, remote AV system 714, and/or V2I infrastructure system 718. In an example, fleet management system 716 includes a server, a group of servers, and/or other like devices. In some embodiments, fleet management system 716 is associated with a ridesharing company (e.g., an organization that controls operation of multiple vehicles (e.g., vehicles that include autonomous systems and/or vehicles that do not include autonomous systems) and/or the like).

In some embodiments, V2I system 718 includes at least one device configured to be in communication with vehicles 702, V2I device 710, remote AV system 714, and/or fleet management system 716 via network 712. In some examples, V2I system 718 is configured to be in communication with V2I device 710 via a connection different from network 712. In some embodiments, V2I system 718 includes a server, a group of servers, and/or other like devices. In some embodiments, V2I system 718 is associated with a municipality or a private institution (e.g., a private institution that maintains V2I device 710 and/or the like).

The number and arrangement of elements illustrated in FIG. 7 are provided as an example. There can be additional elements, fewer elements, different elements, and/or differently arranged elements, than those illustrated in FIG. 7. Additionally, or alternatively, at least one element of environment 700 can perform one or more functions described as being performed by at least one different element of FIG. 7. Additionally, or alternatively, at least one set of elements of environment 700 can perform one or more functions described as being performed by at least one different set of elements of environment 700.

Forego reliance on human intervention in certain situations such as Level 4 ADS-operated vehicles), conditional autonomous vehicles (e.g., vehicles that forego reliance on human intervention in limited situations such as Level 3 ADS-operated vehicles) and/or the like. In one embodiment, autonomous system 802 includes operational or tactical set of elements of environment 700. Referring now to FIG. 8, vehicle 800 (which can be the same as, or similar to vehicles 702 of FIG. 7) includes or is associated with autonomous system 802, powertrain control system 804, steering control system 806, and brake system 1408. In some embodiments, vehicle 800 is the same as or similar to vehicle 702 (see FIG. 7). In some embodiments, autonomous system 802 is configured to confer vehicle 800 autonomous driving capability (e.g., implement at least one driving automation or maneuver-based function, feature, device, and/or the like that enable vehicle 800 to be partially or fully operated without human intervention including, without limitation, fully autonomous vehicles (e.g., vehicles that forego reliance on human intervention such as Level 6 ADS-operated vehicles), highly autonomous vehicles (e.g., vehicles that functionality required to operate vehicle 800 in on-road traffic and perform part or all of Dynamic Driving Task (DDT) on a sustained basis. In another embodiment, autonomous system 802 includes an Advanced Driver Assistance System (ADAS) that includes driver support features. Autonomous system 802 supports various levels of driving automation, ranging from no driving automation (e.g., Level 0) to full driving automation (e.g., Level 6). For a detailed description of fully autonomous vehicles and highly autonomous vehicles, reference can be made to SAE International's standard J3016: Taxonomy and Definitions for Terms Related to On-Road Motor Vehicle Automated Driving Systems, which is incorporated by reference in its entirety. In some embodiments, vehicle 800 is associated with an autonomous fleet manager and/or a ridesharing company.

Autonomous system 802 includes a sensor suite that includes one or more devices such as cameras 802a, lidar sensors 802b, radar sensors 802c, and microphones 802d. In some embodiments, autonomous system 802 can include more or fewer devices and/or different devices (e.g., ultrasonic sensors, inertial sensors, GPS receivers (discussed below), odometry sensors that generate data associated with an indication of a distance that vehicle 800 has traveled, and/or the like). In some embodiments, autonomous system 802 uses the one or more devices included in autonomous system 802 to generate data associated with environment 700, described herein. The data generated by the one or more devices of autonomous system 802 can be used by one or more systems described herein to observe the environment (e.g., environment 700) in which vehicle 800 is located. In some embodiments, autonomous system 802 includes communication device 802e, autonomous vehicle compute 802f, drive-by-wire (DBW) system 802h, and safety controller 802g.

In some cases, at least the lidar sensors 802b of the vehicle 800 can lidar sensors of the lidar system 106 of the vehicle 100, and the cameras 802a can include a camera of the imaging system 102 described above with respect to FIG. 2A.

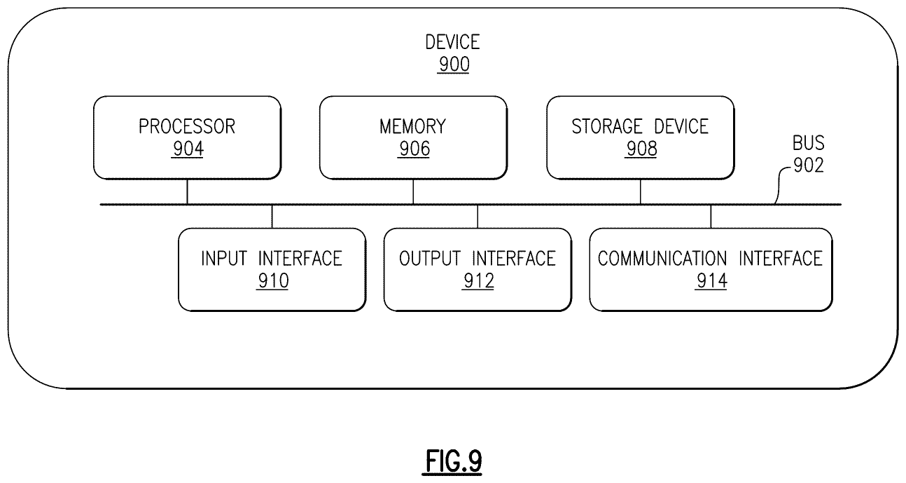

Cameras 802a include at least one device configured to be in communication with communication device 802e, autonomous vehicle compute 802f, and/or safety controller 802g via a bus (e.g., a bus that is the same as or similar to bus 902 of FIG. 9). Cameras 802a include at least one camera (e.g., a digital camera using a light sensor such as a Charge Coupled Device (CCD), a thermal camera, an infrared (IR) camera, an event camera, and/or the like) to capture images including physical objects (e.g., cars, buses, curbs, people, and/or the like). In some embodiments, camera 802a generates camera data as output. In some examples, camera 802a generates camera data that includes image data associated with an image. In this example, the image data can specify at least one parameter (e.g., image characteristics such as exposure, brightness, etc., an image timestamp, and/or the like) corresponding to the image. In such an example, the image can be in a format (e.g., RAW, JPEG, PNG, and/or the like). In some embodiments, camera 802a includes a plurality of independent cameras configured on (e.g., positioned on) a vehicle to capture images for the purpose of stereopsis (stereo vision). In some examples, camera 802a includes a plurality of cameras that generate image data and transmit the image data to autonomous vehicle compute 802f and/or a fleet management system (e.g., a fleet management system that is the same as or similar to fleet management system 716 of FIG. 7). In such an example, autonomous vehicle compute 802f determines depth to one or more objects in a field of view of at least two cameras of the plurality of cameras based on the image data from the at least two cameras. In some embodiments, cameras 802a is configured to capture images of objects within a distance from cameras 802a (e.g., up to 700 meters, up to a kilometer, and/or the like). Accordingly, cameras 802a include features such as sensors and lenses that are optimized for perceiving objects that are at one or more distances from cameras 802a.

In an embodiment, camera 802a includes at least one camera configured to capture one or more images associated with one or more traffic lights, street signs and/or other physical objects that provide visual navigation information. In some embodiments, camera 802a generates traffic light data associated with one or more images. In some examples, camera 802a generates TLD (Traffic Light Detection) data associated with one or more images that include a format (e.g., RAW, JPEG, PNG, and/or the like). In some embodiments, camera 802a that generates TLD data differs from other systems described herein incorporating cameras in that camera 802a can include one or more cameras with a wide field of view (e.g., a wide-angle lens, a fish-eye lens, a lens having a viewing angle of approximately 120 degrees or more, and/or the like) to generate images about as many physical objects as possible.

Light Detection and Ranging (lidar) sensors 802b include at least one device configured to be in communication with communication device 802e, autonomous vehicle compute 802f, and/or safety controller 802g via a bus (e.g., a bus that is the same as or similar to bus 902 of FIG. 9). Lidar sensors 802b include a system configured to transmit light from a light emitter (e.g., a laser transmitter). Light emitted by lidar sensors 802b include light (e.g., infrared light and/or the like) that is outside of the visible spectrum. In some embodiments, during operation, light emitted by lidar sensors 802b encounters a physical object (e.g., a vehicle-and is reflected back to lidar sensors 802b. In some embodiments, the light emitted by lidar sensors 802b does not penetrate the physical objects that the light encounters. Lidar sensors 802b also include at least one light detector which detects the light that was emitted from the light emitter after the light encounters a physical object. In some embodiments, at least one data processing system associated with lidar sensors 802b generates an image (e.g., a point cloud, a combined point cloud, and/or the like) representing the objects included in a field of view of lidar sensors 802b. In some examples, the at least one data processing system associated with lidar sensors 802b generate an image that represents the boundaries of a physical object, the surfaces (e.g., the topology of the surfaces) of the physical object, and/or the like. In such an example, the image is used to determine the boundaries of physical objects in the field of view of lidar sensors 802b.

Radio Detection and Ranging (radar) sensors 802c include at least one device configured to be in communication with communication device 802e, autonomous vehicle compute 802f, and/or safety controller 802g via a bus (e.g., a bus that is the same as or similar to bus 902 of FIG. 9). Radar sensors 802c include a system configured to transmit radio waves (either pulsed or continuously). The radio waves transmitted by radar sensors 802c include radio waves that are within a predetermined spectrum. In some embodiments, during operation, radio waves transmitted by radar sensors 802c encounter a physical object and are reflected back to radar sensors 802c. In some embodiments, the radio waves transmitted by radar sensors 802c are not reflected by some objects. In some embodiments, at least one data processing system associated with radar sensors 802c generates signals representing the objects included in a field of view of radar sensors 802c. For example, the at least one data processing system associated with radar sensors 802c generates an image that represents the boundaries of a physical object, the surfaces (e.g., the topology of the surfaces) of the physical object, and/or the like. In some examples, the image is used to determine the boundaries of physical objects in the field of view of radar sensors 802c.

Microphones 802d includes at least one device configured to be in communication with communication device 802e, autonomous vehicle compute 802f, and/or safety controller 802g via a bus (e.g., a bus that is the same as or similar to bus 902 of FIG. 9). Microphones 802d include one or more microphones (e.g., array microphones, external microphones, and/or the like) that capture audio signals and generate data associated with (e.g., representing) the audio signals. In some examples, microphones 802d include transducer devices and/or like devices. In some embodiments, one or more systems described herein can receive the data generated by microphones 802d and determine a position of an object relative to vehicle 800 (e.g., a distance and/or the like) based on the audio signals associated with the data.

Communication device 802e includes at least one device configured to be in communication with cameras 802a, lidar sensors 802b, radar sensors 802c, microphones 802d, autonomous vehicle compute 802f, safety controller 802g, and/or DBW (Drive-By-Wire) system 802h. For example, communication device 802e can include a device that is the same as or similar to communication interface 914 of FIG. 9. In some embodiments, communication device 802e includes a vehicle-to-vehicle (V2V) communication device (e.g., a device that enables wireless communication of data between vehicles).

Autonomous vehicle compute 802f include at least one device configured to be in communication with cameras 802a, lidar sensors 802b, radar sensors 802c, microphones 802d, communication device 802e, safety controller 802g, and/or DBW system 802h. In some examples, autonomous vehicle compute 802f includes a device such as a client device, a mobile device (e.g., a cellular telephone, a tablet, and/or the like), a server (e.g., a computing device including one or more central processing units, graphical processing units, and/or the like), and/or the like. In some embodiments, autonomous vehicle compute 802f is the same as or similar to autonomous vehicle compute 1000, described herein. Additionally, or alternatively, in some embodiments autonomous vehicle compute 802f is configured to be in communication with an autonomous vehicle system (e.g., an autonomous vehicle system that is the same as or similar to remote AV system 714 of FIG. 7), a fleet management system (e.g., a fleet management system that is the same as or similar to fleet management system 716 of FIG. 7), a V2I device (e.g., a V2I device that is the same as or similar to V2I device 710 of FIG. 7), and/or a V2I system (e.g., a V2I system that is the same as or similar to V2I system 718 of FIG. 7).

Safety controller 802g includes at least one device configured to be in communication with cameras 802a, lidar sensors 802b, radar sensors 802c, microphones 802d, communication device 802e, autonomous vehicle compute 802f, and/or DBW system 802h. In some examples, safety controller 802g includes one or more controllers (electrical controllers, electromechanical controllers, and/or the like) that are configured to generate and/or transmit control signals to operate one or more devices of vehicle 800 (e.g., powertrain control system 804, steering control system 806, brake system 1408, and/or the like). In some embodiments, safety controller 802g is configured to generate control signals that take precedence over (e.g., overrides) control signals generated and/or transmitted by autonomous vehicle compute 802f.

DBW system 802h includes at least one device configured to be in communication with communication device 802e and/or autonomous vehicle compute 802f. In some examples, DBW system 802h includes one or more controllers (e.g., electrical controllers, electromechanical controllers, and/or the like) that are configured to generate and/or transmit control signals to operate one or more devices of vehicle 800 (e.g., powertrain control system 804, steering control system 806, brake system 1408, and/or the like). Additionally, or alternatively, the one or more controllers of DBW system 802h are configured to generate and/or transmit control signals to operate at least one different device (e.g., a turn signal, headlights, door locks, windshield wipers, and/or the like) of vehicle 800.

Powertrain control system 804 includes at least one device configured to be in communication with DBW system 802h. In some examples, powertrain control system 804 includes at least one controller, actuator, and/or the like. In some embodiments, powertrain control system 804 receives control signals from DBW system 802h and powertrain control system 804 causes vehicle 800 to make longitudinal vehicle motion, such as start moving forward, stop moving forward, start moving backward, stop moving backward, accelerate in a direction, decelerate in a direction or to make lateral vehicle motion such as performing a left turn, performing a right turn, and/or the like. In an example, powertrain control system 804 causes the energy (e.g., fuel, electricity, and/or the like) provided to a motor of the vehicle to increase, remain the same, or decrease, thereby causing at least one wheel of vehicle 800 to rotate or not rotate.

Steering control system 806 includes at least one device configured to rotate one or more wheels of vehicle 800. In some examples, steering control system 806 includes at least one controller, actuator, and/or the like. In some embodiments, steering control system 806 causes the front two wheels and/or the rear two wheels of vehicle 800 to rotate to the left or right to cause vehicle 800 to turn to the left or right. In other words, steering control system 806 causes activities necessary for the regulation of the y-axis component of vehicle motion.

Brake system 1408 includes at least one device configured to actuate one or more brakes to cause vehicle 800 to reduce speed and/or remain stationary. In some examples, brake system 1408 includes at least one controller and/or actuator that is configured to cause one or more calipers associated with one or more wheels of vehicle 800 to close on a corresponding rotor of vehicle 800. Additionally, or alternatively, in some examples brake system 1408 includes an automatic emergency braking (AEB) system, a regenerative braking system, and/or the like.

In some embodiments, vehicle 800 includes at least one platform sensor (not explicitly illustrated) that measures or infers properties of a state or a condition of vehicle 800. In some examples, vehicle 800 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like. Although brake system 1408 is illustrated to be located in the near side of vehicle 800 in FIG. 8, brake system 1408 can be located anywhere in vehicle 800.

Referring now to FIG. 9, illustrated is a schematic diagram of a device 900. As illustrated, device 900 includes processor 904, memory 906, storage device 908, input interface 910, output interface 912, communication interface 914, and bus 902. In some embodiments, device 900 corresponds to at least one device of vehicles 702a-702n, at least one device of vehicle 800, and/or one or more devices of network 712. In some embodiments, one or more devices of vehicles 702a-702n, and/or one or more devices of network 712 include at least one device 900 and/or at least one component of device 900. As shown in FIG. 9, device 900 includes bus 902, processor 904, memory 906, storage device 908, input interface 910, output interface 912, and communication interface 914.

Bus 902 includes a component that permits communication among the components of device 900. In some cases, the processor 904 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 906 includes random access memory (RAM), read-only memory (ROM), and/or another type of dynamic and/or static storage device (e.g., flash memory, magnetic memory, optical memory, and/or the like) that stores data and/or instructions for use by processor 904.

Storage device 908 stores data and/or software related to the operation and use of device 900. In some examples, storage device 908 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 910 includes a component that permits device 900 to receive information, such as via user input (e.g., a touchscreen display, a keyboard, a keypad, a mouse, a button, a switch, a microphone, a camera, and/or the like). Additionally or alternatively, in some embodiments input interface 910 includes a sensor that senses information (e.g., a global positioning system (GPS) receiver, an accelerometer, a gyroscope, an actuator, and/or the like). Output interface 912 includes a component that provides output information from device 900 (e.g., a display, a speaker, one or more light-emitting diodes (LEDs), and/or the like).

In some embodiments, communication interface 914 includes a transceiver-like component (e.g., a transceiver, a separate receiver and transmitter, and/or the like) that permits device 900 to communicate with other devices via a wired connection, a wireless connection, or a combination of wired and wireless connections. In some examples, communication interface 914 permits device 900 to receive information from another device and/or provide information to another device. In some examples, communication interface 914 includes an Ethernet interface, an optical interface, a coaxial interface, an infrared interface, a radio frequency (RF) interface, a universal serial bus (USB) interface, a Wi-Fi® interface, a cellular network interface, and/or the like.

In some embodiments, device 900 performs one or more processes described herein. Device 900 performs these processes based on processor 904 executing software instructions stored by a computer-readable medium, such as memory 906 and/or storage device 908. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 906 and/or storage device 908 from another computer-readable medium or from another device via communication interface 914. When executed, software instructions stored in memory 906 and/or storage device 908 cause processor 904 to perform one or more processes described herein. Additionally, or alternatively, hardwired circuitry is used in place of or in combination with software instructions to perform one or more processes described herein. Thus, embodiments described herein are not limited to any specific combination of hardware circuitry and software unless explicitly stated otherwise.

Memory 906 and/or storage device 908 includes data storage or at least one data structure (e.g., a database and/or the like). Device 900 is capable of receiving information from, storing information in, communicating information to, or searching information stored in the data storage or the at least one data structure in memory 906 or storage device 908. In some examples, the information includes network data, input data, output data, or any combination thereof.

In some embodiments, device 900 is configured to execute software instructions that are either stored in memory 906 and/or in the memory of another device (e.g., another device that is the same as or similar to device 900). As used herein, the term “module” refers to at least one instruction stored in memory 906 and/or in the memory of another device that, when executed by processor 904 and/or by a processor of another device (e.g., another device that is the same as or similar to device 900) cause device 900 (e.g., at least one component of device 900) to perform one or more processes described herein. In some embodiments, a module is implemented in software, firmware, hardware, and/or the like.

The number and arrangement of components illustrated in FIG. 9 are provided as an example. In some embodiments, device 900 can include additional components, fewer components, different components, or differently arranged components than those illustrated in FIG. 9. Additionally, or alternatively, a set of components (e.g., one or more components) of device 900 can perform one or more functions described as being performed by another component or another set of components of device 900.

In some implementations, one or more components or systems of the control and processing system 222 can include one or more components of the device 900. For example, the control and processing system 222, can include the processor 904 and/or memory 906. In some cases, the device 900 can include the control and processing system 222 described above.

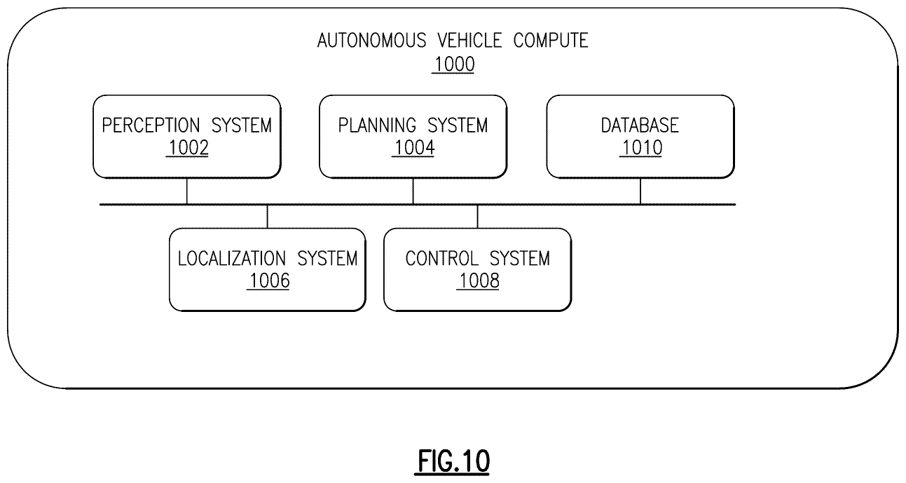

Referring now to FIG. 10, illustrated is an example block diagram of an autonomous vehicle compute 1000 (sometimes referred to as an “AV stack”). As illustrated, autonomous vehicle compute 1000 includes perception system 1002 (sometimes referred to as a perception module), planning system 1004 (sometimes referred to as a planning module), localization system 1006 (sometimes referred to as a localization module), control system 1008 (sometimes referred to as a control module), and database 1010. In some embodiments, perception system 1002, planning system 1004, localization system 1006, control system 1008, and database 1010 are included and/or implemented in an autonomous navigation system of a vehicle (e.g., autonomous vehicle compute 802f of vehicle 800). Additionally, or alternatively, in some embodiments, perception system 1002, planning system 1004, localization system 1006, control system 1008, and database 1010 are included in one or more standalone systems (e.g., one or more systems that are the same as or similar to autonomous vehicle compute 1000 and/or the like). In some examples, perception system 1002, planning system 1004, localization system 1006, control system 1008, and database 1010 are included in one or more standalone systems that are located in a vehicle and/or at least one remote system as described herein. In some embodiments, any and/or all of the systems included in autonomous vehicle compute 1000 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 1000 is configured to be in communication with a remote system (e.g., an autonomous vehicle system that is the same as or similar to remote AV system 714, a fleet management system that is the same as or similar to fleet management system 716, a V2I system that is the same as or similar to V2I system 718, and/or the like).

In some embodiments, perception system 1002 receives data associated with at least one physical object (e.g., data that is used by perception system 1002 to detect the at least one physical object) in an environment and classifies the at least one physical object. In some examples, perception system 1002 receives image data captured by at least one camera (e.g., cameras 802a), the image associated with (e.g., representing) one or more physical objects within a field of view of the at least one camera. In such an example, perception system 1002 classifies at least one physical object based on one or more groupings of physical objects (e.g., bicycles, vehicles, traffic signs, pedestrians, and/or the like). In some embodiments, perception system 1002 transmits data associated with the classification of the physical objects to planning system 1004 based on perception system 1002 classifying the physical objects.

In some embodiments, planning system 1004 receives data associated with a destination and generates data associated with at least one route (e.g., routes 706a-n) along which a vehicle (e.g., vehicles 702) can travel along toward a destination. In some embodiments, planning system 1004 periodically or continuously receives data from perception system 1002 (e.g., data associated with the classification of physical objects, described above) and planning system 1004 updates the at least one trajectory or generates at least one different trajectory based on the data generated by perception system 1002. In other words, planning system 1004 can perform tactical function-related tasks that are required to operate vehicle 702a-702n in on-road traffic. Tactical efforts involve maneuvering the vehicle in traffic during a trip, including but not limited to deciding whether and when to overtake another vehicle, change lanes, or selecting an appropriate speed, acceleration, deacceleration, etc. In some embodiments, planning system 1004 receives data associated with an updated position of a vehicle (e.g., vehicles 702) from localization system 1006 and planning system 1004 updates the at least one trajectory or generates at least one different trajectory based on the data generated by localization system 1006.

In some embodiments, localization system 1006 receives data associated with (e.g., representing) a location of a vehicle (e.g., vehicles 702a-702n) in an area. In some examples, localization system 1006 receives lidar data associated with at least one point cloud generated by at least one lidar sensor (e.g., lidar sensors 802b). In certain examples, localization system 1006 receives data associated with at least one point cloud from multiple lidar sensors and localization system 1006 generates a combined point cloud based on each of the point clouds. In these examples, localization system 1006 compares the at least one point cloud or the combined point cloud to two-dimensional (2D) and/or a three-dimensional (3D) map of the area stored in database 1010. Localization system 1006 then determines the position of the vehicle in the area based on localization system 1006 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 1006 receives Global Navigation Satellite System (GNSS) data generated by a global positioning system (GPS) receiver. In some examples, localization system 1006 receives GNSS data associated with the location of the vehicle in the area and localization system 1006 determines a latitude and longitude of the vehicle in the area. In such an example, localization system 1006 determines the position of the vehicle in the area based on the latitude and longitude of the vehicle. In some embodiments, localization system 1006 generates data associated with the position of the vehicle. In some examples, localization system 1006 generates data associated with the position of the vehicle based on localization system 1006 determining the position of the vehicle. In such an example, the data associated with the position of the vehicle includes data associated with one or more semantic properties corresponding to the position of the vehicle.

In some embodiments, control system 1008 receives data associated with at least one trajectory from planning system 1004 and control system 1008 controls operation of the vehicle. In some examples, control system 1008 receives data associated with at least one trajectory from planning system 1004 and control system 1008 controls operation of the vehicle by generating and transmitting control signals to cause a powertrain control system (e.g., DBW system 802h, powertrain control system 804, and/or the like), a steering control system (e.g., steering control system 806), and/or a brake system (e.g., brake system 1408) to operate. For example, control system 1008 is configured to perform operational functions such as a lateral vehicle motion control or a longitudinal vehicle motion control. The lateral vehicle motion control causes activities necessary for the regulation of the y-axis component of vehicle motion. The longitudinal vehicle motion control causes activities necessary for the regulation of the x-axis component of vehicle motion. In an example, where a trajectory includes a left turn, control system 1008 transmits a control signal to cause steering control system 806 to adjust a steering angle of vehicle 800, thereby causing vehicle 800 to turn left. Additionally, or alternatively, control system 1008 generates and transmits control signals to cause other devices (e.g., headlights, turn signal, door locks, windshield wipers, and/or the like) of vehicle 800 to change states.

In some embodiments, perception system 1002, planning system 1004, localization system 1006, and/or control system 1008 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 1002, planning system 1004, localization system 1006, and/or control system 1008 implement at least one machine learning model alone or in combination with one or more of the above-noted systems. In some examples, perception system 1002, planning system 1004, localization system 1006, and/or control system 1008 implement at least one machine learning model as part of a pipeline (e.g., a pipeline for identifying one or more objects located in an environment and/or the like). Database 1010 stores data that is transmitted to, received from, and/or updated by perception system 1002, planning system 1004, localization system 1006, and/or control system 1008. In some examples, database 1010 includes a storage component (e.g., a storage component that is the same as or similar to storage device 908 of FIG. 9) that stores data and/or software related to the operation and uses at least one system of autonomous vehicle compute 1000. In some embodiments, database 1010 stores data associated with 2D and/or 3D maps of at least one area. In some examples, database 1010 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 702 and/or vehicle 800) can drive along one or more drivable regions (e.g., single-lane roads, multi-lane roads, highways, back roads, off road trails, and/or the like) and cause at least one lidar sensor (e.g., a lidar sensor that is the same as or similar to lidar sensors 802b) to generate data associated with an image representing the objects included in a field of view of the at least one lidar sensor.

In some embodiments, database 1010 can be implemented across a plurality of devices. In some examples, database 1010 is included in a vehicle (e.g., a vehicle that is the same as or similar to vehicles 702a-702n and/or vehicle 800), an autonomous vehicle system (e.g., an autonomous vehicle system that is the same as or similar to remote AV system 714, a fleet management system (e.g., a fleet management system that is the same as or similar to fleet management system 716 of FIG. 7, a V2I system (e.g., a V2I system that is the same as or similar to V2I system 718 of FIG. 7) and/or the like.

In various embodiments, the method and systems described above with respect to identifying and characterizing the NIR spots for generating alerts, determining vehicle profile, and/or generating a modified digital image (e.g., a digital image with a reduced number of NIR spots), can be used to identify and characterize bright spots associated with light having wavelength in other spectral ranges different from NIR spectral range. A bright spot on a digital image can be a be a region (e.g., a subset of pixels) in the digital image having a brightness level larger than a threshold brightness level. The threshold brightness level can be a brightness level, larger than a standard deviation of brightness level of the digital image from a mean value of the brightness level over the digital image, by factor of 2, 4, 6 time, 10, or larger values. A bright spot can be generated by a light source of a vehicle or other light sources. In some cases, the light source can be a laser and the bright spot can be referred to as laser spot (e.g., NIR laser spot). In some cases, a portion of bright spot can include pixels that could potentially represent an image of a portion of a scene near the light source but are saturated by the light from the light source.

### EXAMPLE EMBODIMENTS

Some additional nonlimiting examples of embodiments discussed above are provided below. These should not be read as limiting the breadth of the disclosure in any way.

### Group 1

Example 1. An imaging system of a vehicle, comprising:
an optical subsystem configured to:
receive light from a scene,
divide the received light into a first portion and a second portion having different spectral distributions;
form a first image of the scene using the first portion, and
form a second image of the scene using the second portion,
a first image sensor configured to generate a first digital image using the first image of the scene;
a second image sensor configured to generate a second digital image using the second image of the scene; and
at least one processor configured to modify the first digital image based at least in part on the second digital image to generate a modified digital image;
wherein the first image of the scene and the second image of the scene comprise a same portion of the scene.

Example 2. The imaging system of Example 1, wherein the first image sensor and the second image sensor have similar spectral responses.

Example 3. The imaging system of Example 2, wherein a difference between a peak response wavelength of the first image sensor and a peak response wavelength of the second image sensor is less than 10 nm.

Example 4. The imaging system of Example 1, wherein one or both of a peak response wavelength or a response bandwidth of the first image sensor and second image sensor are between 400 and 1100 nm.

Example 5. The imaging system of Example 1, wherein the first image sensor and the second image sensor comprise CMOS sensors.

Example 6. The imaging system of Example 1, a spectral distribution of the first portion has a mean value within visible (VIS) wavelength range and a spectral distribution of the second portion has a mean value within near infrared (NIR) wavelength range.

Example 7. The imaging system of Example 6, wherein the optical subsystem is configured to form the first image of the scene via a first optical path and form the second image of the scene via a second optical path different from the first optical path, wherein optical transmission of the first optical path is greater than the optical transmission of the second optical path for light having wavelengths in VIS wavelength range.

Example 8. The imaging system of Example 7, further comprising at least one optical surface having greater optical transmission for light having wavelengths in VIS wavelength range compared to light having wavelengths in NIR wavelength range.

Example 9. The imaging system of Example 1, wherein the optical subsystem comprises an objective optical train, a first optical train, a second optical train, and a dichroic beam splitter that receives light from the scene through the objective optical train, transmits the first portion to the first optical train, and redirects the second portion to the second optical train.

Example 10. The imaging system of Example 9, wherein a spectral distribution of the first portion has a mean value within visible (VIS) wavelength range and a spectral distribution of the second portion has a mean value within near infrared (NIR) wavelength range.

Example 11. The imaging system of Example 9, wherein the first optical train forms the first image on the first image sensor and the second optical train forms the second image on the second image sensor.

Example 12. The imaging system of Example 9, wherein the first optical train and the second optical train comprise substantially identical arrangement of optical components.

Example 13. The imaging system of Example 1, wherein the imaging system comprises a camera of a navigation system of the vehicle.

Example 14. The imaging system of Example 1, wherein a first normalized brightness of at least a first image portion of the first digital image is less than a second normalized brightness of a respective image portion of the second digital image and larger than a third normalized brightness of a respective image portion of the modified digital image.

Example 15. The imaging system of Example 14, wherein each of the first normalized brightness, the second normalized brightness, and the third normalized brightness is normalized to a maximum brightness of the respective digital image.

Example 16. The imaging system of Example 1, wherein to generate the modified digital image, the at least one processor is configured to compare the first digital image and the second digital image.

Example 17. The imaging system of Example 1, wherein the at least one processor is further configured to:
identify a first bright region on the first digital image,
identify a second bright region on the second digital image that corresponds to the first bright region,
compare a brightness level of the first and second bright regions, and
in response to determining that the brightness level the second bright region is greater than that of the first bright region, modify the first digital image by reducing a brightness of the first bright region.

Example 18. The imaging system of Example 17, wherein the first bright region comprises a first group of pixels in the first digital image and the second bright region comprises a second group of pixels in the second digital image, wherein the second group of pixels correspond to the first group of pixels, and wherein the first group of pixels and the second group of pixels are illuminated with light from a NIR light source in the scene.

Example 19. The imaging system of Example 18, wherein the NIR light source comprises a laser source of another vehicle in the scene.

Example 20. The imaging system of Example 19, wherein to reduce a brightness of the first bright region, the at least one processor is configured to remove at least one laser spot from the first digital image, wherein the laser spot corresponds to light received from a lidar system of the other vehicle.

Example 21. The imaging system of Example 1, wherein the processor is configured to modify the first digital image by replacing the first digital image with a substitute digital image comprising the same portion of the scene, wherein at least one laser spot on the first digital image does not appear on the substitute digital image.

Example 22. The imaging system of Example 1, wherein the at least one processor is further configured to operate the imaging system in sync with a lidar system of the vehicle to receive a first portion of a first image signal generated by the first image sensor and a first portion of a second image signal generated by the second image sensor during emission of an optical pulse by the lidar system of the vehicle and a second portion of the first image signal and a second portion of the second image signal after emission of the optical pulse and before emission of a next optical pulse.

Example 23. The imaging system of Example 22, wherein the first portion of the first image signal comprises the first digital image, the second portion of the first image signal comprises a third digital image, the first portion of the second image signal comprises the second digital image, and the second portion of the second image signal comprises a fourth digital image.

Example 24. The imaging system of Example 23, wherein the at least one processor is further configured to compare the second digital image and the fourth digital image to identify a group of bright spots on at least one of the first digital image or the third digital image, wherein the group of bright spots correspond to light from a light source of another vehicle.

Example 25. The imaging system of Example 24, wherein the at least one processor is further configured to compare the first digital image and the third digital image to identify the group of bright spots on at least one of the first digital image or the third digital image.

Example 26. The imaging system of Example 23, wherein the at least one processor is further configured to modify the first digital image using the third digital image and the fourth digital image to generate the modified digital image.

Example 27. The imaging system of Example 26, wherein the at least one processor is configured to:
identify a third bright region on at least one of the first digital image or the third digital image,
identify a fourth bright region on at least one of the second digital image or the fourth digital image that corresponds to the third bright region,
compare a brightness level of the third and fourth bright regions, and
in response to determining that the brightness level the fourth bright region is greater than that of the third bright region, modify the first digital image by reducing a brightness of the third bright region.

Example 28. The imaging system of Example 24, wherein the at least one processor is further configured to identify a spatial arrangement of the group of bright spots and determine a characteristic of the light source based at least in part on the spatial arrangement of the group of bright spots.

Example 29. The imaging system of Example 28, wherein the light source comprises the lidar system of the other vehicle.

Example 30. The imaging system of Example 28, wherein the at least one processor is further configured to determine a profile of the other vehicle using the determined characteristics.

### Group 2

Example 1. A method comprising:
by an optical subsystem of an imaging system of a vehicle:
   receiving light from a scene;
   dividing the received light into a first portion and a second portion having different spectral distributions;
   forming a first image on a first image sensor using the first portion of the received light
   forming a second image on a second image sensor using the second portion of the received light, wherein the first image and the second image, comprise a same imaged portion of the scene with the same magnification;
   receiving, by at least one processor of the imaging system, at least a first digital image from the first image sensor and at least a second digital image from the second image sensor; and
   generating, by the at least one processor, a modified digital image by modifying the first digital image based at least in part on the second digital image.

Example 2. The method of Example 1, wherein the first image sensor and the second image sensor have similar spectral responses.

Example 3. The method of Example 2, wherein a difference between a peak response wavelength of the first image sensor and a peak response wavelength of the second image sensor is less than 10 nm.

Example 4. The method of Example 1, wherein one or both of a peak response wavelength or a response bandwidth of the first image sensor and second image sensor are between 400 and 1100 nm.

Example 5. The method of Example 1, wherein the first image sensor and the second image sensor comprise CMOS sensors.

Example 6. The method of Example 1, a spectral distribution of the first portion has a mean value within visible (VIS) wavelength range and a spectral distribution of the second portion has a mean value within near infrared (NIR) wavelength range.

Example 7. The method of Example 6, further comprising forming the first image of the scene via a first optical path and forming the second image of the scene via a second optical path different from the first optical path, wherein optical transmission of the first optical path is greater than the optical transmission of the second optical path for light having wavelengths in VIS wavelength range.

Example 8. The method of Example 1, wherein dividing the received light into a first portion and a second portion comprises, by a dichroic beam splitter, transmitting the first portion to a first optical train of the optical subsystem, and transmitting the second portion to a second optical train of the optical subsystem.

Example 9. The method of Example 8, wherein a spectral distribution of the first portion has a mean value within visible (VIS) wavelength range and a spectral distribution of the second portion has a mean value within near infrared (NIR) wavelength range.

Example 10. The method of Example 9, wherein forming the first image comprises forming the first image using the first optical train, and forming the second image comprises forming the second image using the second optical train.

Example 11. The method of Example 8, wherein the first optical train and the second optical train comprise substantially identical arrangement of optical components.

Example 12. The method of Example 1, wherein the imaging system comprises a camera of a navigation system of the vehicle.

Example 13. The method of Example 1, wherein a first normalized brightness of at least a first image portion of the first digital image is less than a second normalized brightness of a respective image portion of the second digital image and larger than a third normalized brightness of a respective image portion of the modified digital image.

Example 14. The method of Example 13, wherein each of the first normalized brightness, the second normalized brightness, and the third normalized brightness is normalized to a maximum brightness of the respective digital image.

Example 15. The method of Example 1, wherein generating the modified digital image comprises comparing the first digital image and the second digital image.

Example 16. The method of Example 1, wherein generating the modified digital image comprises:
identifying a first spot on the first digital image,
identifying a second spot on the second digital image that corresponds to the first spot,
comparing a brightness level of the first and second spots, and
in response to determining that the brightness level the second spot is greater than that of the first spot, modifying the first digital image.

Example 17. The method of Example 16, wherein modifying the first digital image comprises replacing the first digital image with a substitute digital image comprising the same imaged portion of the scene, wherein the substitute digital image does not include a spot corresponding to the first spot.

Example 18. The method of Example 16, wherein modifying the first digital image comprises reducing a brightness of the first spot on the first digital image.

Example 19. The method of Example 18, wherein the first spot comprises a first group of pixels in the first digital image and the second spot comprises a second group of pixels in the second digital image, wherein the second group of pixels correspond to the first group of pixels, and wherein the first group of pixels and the second group of pixels are illuminated with light from a NIR light source in the scene.

Example 20. The method of Example 19, wherein the NIR light source comprises a laser source of another vehicle in the scene.

Example 21. The method of Example 20, wherein reducing a brightness of the first spot comprises removing at least one laser spot from the first digital image, wherein the laser spot corresponds to light received from a lidar system of the other vehicle.

Example 22. The method of Example 1, further comprising:
operating the imaging system in sync with a lidar system of the vehicle;
receiving a first portion of a first image signal generated by the first image sensor and a first portion of a second image signal generated by the second image sensor during emission of an optical pulse by the lidar system of the vehicle; and
receiving a second portion of the first image signal and a second portion of the second image signal after emission of the optical pulse and before emission of a next optical pulse.

Example 23. The method of Example 22, wherein the first portion of the first image signal comprises the first digital image, the second portion of the first image signal comprises a third digital image, the first portion of the second image signal comprises the second digital image, and the second portion of the second image signal comprises a fourth digital image.

Example 24. The method of Example 23, further comprising:
comparing the second digital image and the fourth digital image; and
identifying a group of spots on at least one of the first digital image or the third digital image, wherein the group of spots correspond to light from a light source of another vehicle.

Example 25. The method of Example 24, wherein identifying the group of spots further comprises comparing the first digital image and the third digital image.

Example 26. The method of Example 23, wherein modifying the first digital image comprises modifying the first digital image using the third digital image and the fourth digital image.

Example 27. The method of Example 24, further comprising:
identifying a third spot on at least one of the first digital image or the third digital image,
identifying a fourth spot on at least one of the second digital image or the fourth digital image that corresponds to the third spot,
comparing a brightness level of the third and fourth spots, and
in response to determining that the brightness level of the fourth spot is greater than that of the third spot, reducing a brightness of the third spot.

Example 28. The method of Example 24, further comprising identifying a spatial arrangement of the group of spots and determining a characteristic of the light source based at least in part on the spatial arrangement of the group of spots.

Example 29. The method of Example 24, wherein the light source comprises the lidar system of the other vehicle.

Example 30. The method of Example 28, further comprising determining a profile of the other vehicle using the determined characteristics.

### Group 3

Example 1. A method, comprising:
receiving a visible digital image with a first plurality of bright spots;
receiving a near-infrared digital image with a second plurality of bright spots;
comparing the first plurality of bright spots with the second plurality of bright spots to identify at least one difference between the first plurality of bright spots and the second plurality of bright spots; and
generating an alert based on the at least one difference between the first plurality of bright spots and the second plurality of bright spots.

### Group 4

Example 1. A method, comprising:
causing, during a first time period, a lidar to emit a lidar signal;
receiving, during the first time period, a first near-infrared digital image based on the emission of the lidar signal, the first near-infrared digital image comprising at least one first bright spot;
receiving, at a second time period, a second near-infrared digital image, the second near-infrared digital image comprising at least one second bright spot;
determining the at least one second bright spot corresponds to a light source of a vehicle, wherein the light source is different from the lidar; and
determining at least one property of the vehicle based on the at least one second bright spot.

### Terminology

In this description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, modules, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element cannot be included in or combined with other elements in some embodiments unless explicitly described as such.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “includes,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

What is claimed is

1. An imaging system of a vehicle, comprising:
an optical subsystem configured to:
receive light from a scene,
divide the received light into a first portion and a second portion having different spectral distributions;
form a first image of the scene using the first portion, and
form a second image of the scene using the second portion,
a first image sensor configured to generate a first digital image using the first image of the scene;
a second image sensor configured to generate a second digital image using the second image of the scene; and
at least one processor configured to modify the first digital image based at least in part on the second digital image to generate a modified digital image;
wherein the first image of the scene and the second image of the scene comprise a same portion of the scene.

2. The imaging system of claim 1, wherein the first image sensor and the second image sensor have similar spectral responses.

3. The imaging system of claim 2, wherein a difference between a peak response wavelength of the first image sensor and a peak response wavelength of the second image sensor is less than 10 nm.

4. The imaging system of claim 1, wherein one or both of a peak response wavelength or a response bandwidth of the first image sensor and second image sensor are between 400 and 1100 nm.

5. The imaging system of claim 1, a spectral distribution of the first portion has a mean value within visible (VIS) wavelength range and a spectral distribution of the second portion has a mean value within near infrared (NIR) wavelength range.

6. The imaging system of claim 5, wherein the optical subsystem is configured to form the first image of the scene via a first optical path and form the second image of the scene via a second optical path different from the first optical path, wherein optical transmission of the first optical path is greater than the optical transmission of the second optical path for light having wavelengths in VIS wavelength range.

7. The imaging system of claim 1, wherein the at least one processor is further configured to:
identify a first bright region on the first digital image,
identify a second bright region on the second digital image that corresponds to the first bright region,
compare a brightness level of the first and second bright regions, and
in response to determining that the brightness level the second bright region is greater than that of the first bright region, modify the first digital image by reducing a brightness of the first bright region.

8. The imaging system of claim 7, wherein the first bright region comprises a first group of pixels in the first digital image and the second bright region comprises a second group of pixels in the second digital image, wherein the second group of pixels correspond to the first group of pixels, and wherein the first group of pixels and the second group of pixels are illuminated with light from a NIR light source in the scene.

9. The imaging system of claim 1, wherein the at least one processor is further configured to operate the imaging system in sync with a lidar system of the vehicle to receive a first portion of a first image signal generated by the first image sensor and a first portion of a second image signal generated by the second image sensor during emission of an optical pulse by the lidar system of the vehicle and a second portion of the first image signal and a second portion of the second image signal after emission of the optical pulse and before emission of a next optical pulse.

10. A method comprising:
receiving, by an optical subsystem of an imaging system of a vehicle, light from a scene;
dividing, by the optical subsystem, the received light into a first portion and a second portion having different spectral distributions;
forming, by the optical subsystem, a first image on a first image sensor using the first portion of the received light
forming, by the optical subsystem, a second image on a second image sensor using the second portion of the received light, wherein the first image and the second image, comprise a same imaged portion of the scene with the same magnification;
receiving, by at least one processor of the imaging system, at least a first digital image from the first image sensor and at least a second digital image from the second image sensor; and
generating, by the at least one processor, a modified digital image by modifying the first digital image based at least in part on the second digital image.

11. The method of claim 10, wherein a difference between a peak response wavelength of the first image sensor and a peak response wavelength of the second image sensor is less than 10 nm.

12. The method of claim 10, wherein one or both of a peak response wavelength or a response bandwidth of the first image sensor and second image sensor are between 400 and 1100 nm.

13. The method of claim 10, wherein a spectral distribution of the first portion has a mean value within visible (VIS) wavelength range and a spectral distribution of the second portion has a mean value within near infrared (NIR) wavelength range.

14. The method of claim 13, further comprising forming the first image of the scene via a first optical path and forming the second image of the scene via a second optical path different from the first optical path, wherein optical transmission of the first optical path is greater than the optical transmission of the second optical path for light having wavelengths in VIS wavelength range.

15. The method of claim 10, wherein generating the modified digital image comprises:
identifying a first spot on the first digital image,
identifying a second spot on the second digital image that corresponds to the first spot,
comparing a brightness level of the first and second spots, and
in response to determining that the brightness level the second spot is greater than that of the first spot, modifying the first digital image.

16. The method of claim 15, wherein modifying the first digital image comprises replacing the first digital image with a substitute digital image comprising the same imaged portion of the scene, wherein the substitute digital image does not include a spot corresponding to the first spot.

17. The method of claim 10, further comprising:
operating the imaging system in sync with a lidar system of the vehicle;
receiving a first portion of a first image signal generated by the first image sensor and a first portion of a second image signal generated by the second image sensor during emission of an optical pulse by the lidar system of the vehicle; and
receiving a second portion of the first image signal and a second portion of the second image signal after emission of the optical pulse and before emission of a next optical pulse.

18. The method of claim 17, wherein the first portion of the first image signal comprises the first digital image, the second portion of the first image signal comprises a third digital image, the first portion of the second image signal comprises the second digital image, and the second portion of the second image signal comprises a fourth digital image.

19. The method of claim 18, further comprising:
comparing the second digital image and the fourth digital image; and
identifying a group of spots on at least one of the first digital image or the third digital image, wherein the group of spots correspond to light from a light source of another vehicle.

20. The method of claim 19, further comprising identifying a spatial arrangement of the group of spots and determining a characteristic of the light source based at least in part on the spatial arrangement of the group of spots.
